(19) United States
(12) Patent Application Publication
(10) Pub. No.: US 2018/0210517 A1
(43) Pub. Date: Jul. 26, 2018

(54) SSD DOUBLER, AND MULTI-DEVICE BAY SYSTEM AND COMPUTER SYSTEM USING SAME

(71) Applicant: STORAGEAN, INC., Bucheon-si (KR)

(72) Inventor: Donggoo YUN, Seoul (KR)

(21) Appl. No.: 15/738,881

(22) PCT Filed: Oct. 5, 2016
(86) PCT No.: PCT/KR2016/011146

§ 371 Date: Dec. 21, 2017

(30) Foreign Application Priority Data
Oct. 6, 2015 (KR) 10-2015-0140135
Nov. 30, 2015 (KR) 10-2015-0168782

(51) Int. Cl. G06F 1/18; G06F 3/06

(52) U.S. Cl. CPC G06F 1/181; G06F 1/185; G06F 3/0689; G06F 1/187

(57) ABSTRACT

An SSD doubler is provided. The SSD doubler comprises: a printed circuit board; a first connector portion which is disposed in a horizontal direction with respect to the printed circuit board and connected to the outside; a second connector portion which is disposed in a horizontal direction with respect to the printed circuit board, is arranged in parallel with the first connector portion, and is connected to the outside; a sixth connector portion which connects the first connector portion to a first storage media; a fourth connector portion which connects the second connector portion to a second storage media or a third storage media; and a bay body which forms a plurality of bays in a vertical direction so as to guide the first storage media and the second storage media or the first storage media, the second storage media, and the third storage media toward the sixth connector portion and the fourth connector portion in a stacked structure.

### TECHNICAL FIELD

The present invention relates to a solid-state drive (SSD) doubler, and a multi-device bay system and a computer system using the SSD doubler.

### BACKGROUND ART

Generally, there are various kinds of mounting units for mounting a solid-state drive (SSD) instead of a 3.5-inch hard disk drive (HDD). A representative example other than simple bracket-type mounting units is a conventional SSD holder 50 shown in FIG. 1.

As main elements of the SSD holder 50 shown in FIG. 1, the SSD holder 50 includes an outer case 51 forming a main external appearance of the SSD holder 50, a printed circuit board 52 built into a rear surface of the outer case 51, an eleventh connection port 53 for an upper SSD and a twelfth connection port 54 for a lower SSD, which are included in the printed circuit board 52, a front panel 55, an operation indicator light-emitting diode (LED) 56, and a handle-combined opening/closing device 57 divided into an upper portion and a lower portion, and also includes a rear panel 58 composed of a thirteenth connection port 58a for an interface and a fourteenth connection port 58b for a power source and an interface.

However, the conventional SSD holder 50 shown in FIG. 1 has the thirteenth connection port 58a and the fourteenth connection port 58b, which are located at an upper portion and a lower portion of the SSD holder 50 for the purpose of external interfaces, disposed to match the rear cover 58. Thus, naturally, the printed circuit board 52 in which the connection ports are disposed has to be disposed at a deep inner position near the rear cover 58.

Thus, SSDs should be moved to the deep inner position of the outer case 51 so that the SSDs can be inserted into the eleventh and twelfth connection ports 53 and 54 from the outside disposed in the printed circuit board 52. When the SSDs are withdrawn from the inner position to the outside, a separate structure (not shown) connected to the handle-combined opening/closing device 57 at a corresponding position and configured to mechanically deliver power pushes the SSDs outward from the deep inner position of the outer case 51. Thus, the SSD holder 50 should have many mechanical elements, and thus is heavy and entirely thick.

Furthermore, since a separate controller for integrating mounted SSDs with respect to a circuit is not included in the printed circuit board 52 built into the conventional SSD holder 50 shown in FIG. 1, a function of logically integrating two SSDs to form a single volume is not supported, and thus the thirteenth and fourteenth connection ports 58a and 58b for external interfaces corresponding to the SSDs have to be separately included in the rear cover 58.

Also, for the SSD holder 50 shown in FIG. 1, the thirteenth and fourteenth connection ports 58a and 58b and the printed circuit board 52 having the eleventh and twelfth connection ports 53 and 54 for SSD connection are arranged in a direction perpendicular to an SSD mounting direction. Thus, the printed circuit board 52 basically serves as a shield plate for blocking air flow, which necessarily causes a long-term reliability problem for stable operation of the mounted SSDs.

### DETAILED DESCRIPTION OF THE INVENTION

### Technical Problem

The present invention is intended to solve the above problems. An object of the present invention is to provide a solid-state drive (SSD) doubler capable of allowing SSDs to be vertically stacked and mounted, the SSDs to be stably held without a separate bolt or the SSD to be easily separated and withdrawn therefrom, and one or more SSDs to be firmly fastened in a vertical or horizontal direction through a bay body without using fastening holes provided at side surfaces of the SSDs even though the SSDs have various thicknesses.

Another object of the present invention is to provide an SSD doubler having an additional interface port in addition to a default interface port and capable of improving operation performance due to the additional interface port allowing a redundant array of independent disks (RAID) configuration to be achieved from the outside of the SSD doubler, such as a computer motherboard or a RAID card.

Still another object of the present invention is to provide an SSD doubler including a power switching unit configured to generate +5V power without a separate controller through an internal power source unit by means of +12V power that is input from power pins of a connector portion, which is configured as a default external interface port, and configured to transfer the +5V power generated by the internal power source unit or +5V power directly input from the power pins of the connector portion to an inserted storage medium depending on whether the +12V power is input.

Still another object of the present invention is to provide an SSD doubler capable of corresponding a single operation monitoring signal, which is obtained by merging operation monitoring signals output from storage media inserted into the SSD doubler, to operation monitoring pins of the connector, or capable of transferring operation monitoring signals, which are output from all storage media except a storage medium directly connected to an interface signal of a connector portion, to the outside through light emitting diodes (LEDs) disposed next to a connector configured as an additional interface port by means of an LED display unit as LED emitted light signals.

Still another object of the present invention is to provide a PCI Express or PCIe add-in card type SSD doubler for solving a problem of not being able to exceed a thickness or width of a 3.5-inch hard disk driver when the number of bays or external interface ports for accommodating storage media inserted into the SSD doubler from the outside is increased.

Still another object of the present invention is to provide a bay support fixture capable of stably guiding, accommodating, and firmly holding a storage medium inserted into the SSD doubler of the present invention.

Still another object of the present invention is to provide a multi-device bay system capable of recognizing storage media as totally independent storage media and separately operating the store media when an SSD doubler having multiple interface ports is installed in the multi-device bay system by connection units corresponding to the multi interface ports being included at a backplane board of the multi-device bay system and also a conversion unit configured to receive operation monitoring signals output from the storage media in the form of LED light and covert the operation monitoring signals into general electric signals being included in the multi-bay system.

### Technical Solution

A solid-state drive (SSD) doubler includes a printed circuit board; a first connector portion provided horizontally to the printed circuit board and connected to an outside; a controller connected to the first connector portion; a sixth connector portion configured to connect the controller to a first storage medium; a fourth connector portion configured to connect the controller to a second storage medium; and a bay body configured to vertically form a plurality of bays so that the first storage medium and the second storage medium are guided toward the sixth connector portion and the fourth connector portion in a stacked structure.

According to another aspect, An SSD doubler having a multi-interface port includes: a printed circuit board; a first connector portion provided horizontally to the printed circuit board and connected to an outside; at least one second connector portion provided horizontally to the printed circuit board, disposed alongside the first connector portion, and connected to the outside; a sixth connector portion configured to connect the first connector portion to a first storage medium; a fourth connector portion configured to connect the second connector portion to a second storage medium or a third storage medium; and a bay body configured to vertically form a plurality of bays so that the first storage medium and the second storage medium or the first storage medium, the second storage medium, and the third storage medium are guided toward the sixth connector portion and the fourth connector portion in a stacked structure.

According to another aspect, an SSD doubler of a PCI Express card type includes a printed circuit board having PCI Express edge fingers; at least one bay body fastened in surface contact with the printed circuit board and configured to form a plurality of stacked unit bays; a first connector portion oriented toward an entrance of the bay body, fastened to the printed circuit board, and configured to correspond to a lower bay of the bay body; a second connector portion disposed alongside the first connector portion in a forward or backward direction and configured to correspond to an upper bay of the bay body; a first external interface port connected to the first connector portion; and a second external interface port connected to the second connector portion.

Also, the sixth connector portion is provided horizontally to the printed circuit board, and the fourth connector portion is provided, as a single connector portion or a plurality of connector portions, vertically to the printed circuit board.

Also, the SSD doubler further includes a vertical connection board connected to the fourth connector portion and at least one fifth connector portion vertically connected at one side of the vertical connection board, wherein a second storage medium or a third storage medium is correspondingly connected to the fifth connector portion.

Also, the bay body is formed in one body.

Also, the bay body is divided into a left body and a right body.

Also, the fourth connector portion and the sixth connector portion, which correspond to the first connector and the second connector, respectively, configure connection by means of a SATA (or SATA Express or SAS) or PCI Express interface signal.

Also, the controller configures connection by means of a SATA (or SATA Express or SAS) and/or PCI Express interface signal(s).

Also, when the fourth connector portion is a SATA connector, +3.3V power pins and adjacent ground pins of the SATA connector are mapped to pins corresponding to an additional interface signal of the second connector portion.

Also, the SSD doubler further include a front cover having a structure surrounding at least one outer surface of the first connector portion and the second connector portion.

Also, the front cover has a vent hole configured to facilitate air flow to an inner side with respect to the front cover by adhering to top surfaces of the first connector portion and the second connector portion without surrounding left and right side surfaces of the first connector portion and left and right side surfaces of the second connector portion.

Also, the vertical connection board is fastened to a vertical connection board fastening protrusion of the bay body by means of a fastening unit.

Also, when the vertical connection board is fastened to one side of the vertical connection board fastening protrusion by means of a fastening bolt, the vertical connection board is fastened through a fastening hole provided in a front cover positioned at an opposite side of the vertical connection board fastening protrusion.

Also, the bay body has a plurality of guide bars configured to guide an inserted storage medium and form stacked bays.

Also, an elastic guide bar configured to press the inserted storage medium downward by means of elasticity is provided at an end of an entrance of each of the guide bars, and a storage medium supporting protrusion is provided at an end portion of the elastic guide bar.

Also, the bay body has side holders positioned at both sides of each of the bays and inwardly protruding from the bay body to push a storage medium by means of elasticity thereof so that a storage medium inserted into each of the bays is stably guided and prevented from deviating outwards.

Also, the bay body has an opening hole on an arbitrary horizontal surface of a bay configuration area that is in surface contact with the printed circuit board, and the bay body has a series of connection units for remotely controlling operations on an exposed printed circuit board within the opening hole.

Also, the bay body has a fastening hole on a side surface thereof at a position corresponding that of a fastening hole provided at a side surface of a storage medium when the storage medium is maximally inserted.

Also, the bay body has an operation mode setting unit on an arbitrary horizontal surface of a bay configuration area that is in surface contact with the printed circuit board.

Also, the SSD doubler further includes an operation recognition switch disposed at an upper portion of an end surface of the printed circuit board in which a storage medium entrance of the bay body for convenience of operation.

Also, when the first storage medium and the second storage medium are installed, the controller enables the operation mode setting unit to select one of RAID0, RAID1, SPAN, and an operation mode for individual storage media, and when the operation recognition switch is pressed, the controller enables the operation mode setting unit to deliver the setting status to the controller.

Also, the bay body has a “∩”-shaped groove disposed at a bottom surface so that a light-emitting diode (LED) is disposed thereon.

Also, the SSD doubler further includes an LED light guide unit for an upper bay and an LED light guide unit for a lower lay disposed at both corners of the printed circuit board at a side of the storage medium entrance of the bay body.

Also, the LED light guide unit has a “¬”-shaped opening groove on a bottom surface, and an LED is disposed on a printed circuit board below the opening groove to monitor an operation status.

Also, the bay body has a storage medium fastening hole disposed at the storage medium entrance in the form of a “U”-shaped opening hole so that a storage medium is easily removed by mounting a separate storage medium removal unit on fastening holes at both sides of the storage medium through the “U”-shaped opening hole and then pulling the storage medium removal unit.

Also, a plurality of bay bodies are disposed on the printed circuit board in a stacked structure to form multiple stages of bays.

Also, when there are a plurality of bay bodies, the controller is configured to additionally support an operation mode such as RAID3, RAID5, RAID6, RAID10, RAID50, or RAID60 as the number of storage media increases.

Also, a unit SSD doubler composed of the first connector portion, the second connector portion, and the bay body is disposed in the same direction as that of the PCIe edge fingers so that the storage medium entrance of the bay body is disposed in a direction opposite to that of the PCIe edge fingers.

Also, the SSD doubler further includes such a unit SSD doubler, wherein the unit SSD doublers are disposed alongside each other in a single-layered structure.

Also, the SSD doubler further includes a cross bar having a vertical connection board fastening hole, wherein the SSD doublers are connected to each other by the cross bar by placing the cross bar in surface contact with the end surface of the bay body of each of the SSD doublers and fastening the SSD doublers to the vertical connection board fastening hole included in the cross bar through a fastening hole of a vertical connection board fastening protrusion of the bay body by means of a fastening unit.

Also, the SSD doubler additionally has a fastening bracket including a through hole on an extension line corresponding to a side fastening hole of an adjacent bay body.

Also, the bay body is made of a transparent material and has a concave-convex groove on a bottom surface that is in surface contact with the printed circuit board, and an LED capable of monitoring an operation status of a storage media installed in the bay body is covered with the concave-convex groove to use the entirety of the bay body as an LED light guide plate and a operation monitoring unit.

Also, the PCI Express edge fingers of the printed circuit board are provided as PCI Express ×1 and are capable of being mounted on any kinds of PCI Express slots.

Also, the printed circuit board has a vent hole to facilitate heat dissipation of a storage medium mounted at a lower portion of the SSD doubler.

Also, the bay body has opening holes for placing external interface connector at left and right sides, and the first external interface port and the second external interface port are disposed on the opening holes.

Also, the SSD doubler further includes a separate LED, wherein logical conjunction is performed on operation monitoring signals output from the first connector portion and the second connector portion to obtain a merged operation monitoring signal, and the merged operation monitoring signal is output through the separate LED.

Also, the printed circuit board has a universal signal input/output IC connected to data input/output pins of the PCI Express fingers, and a fault detection LED is operated according to a signal output from the universal signal input/output IC so that a faulty storage medium is intuitively displayed.

Also, the printed circuit board has a universal signal input/output IC connected to data input/output pins of the PCI Express fingers, and all fault detection LEDs are operated according to all fault signals output from the universal signal input/output IC or a logical conjunction of the individual fault signals in order to display that a fault has occurred in any storage medium.

Also, the SSD doubler further includes a light emitting unit for optical transmission disposed alongside connectors constituting the second connector portion and configured to output operation monitoring signals output from the storage media.

According to another aspect, a computer system includes a central processing unit configured to process operations; a system memory configured to store an operating system, register information regarding various kinds of devices, and an operation processing result; a memory channel hub configured to connect the central processing unit to a main memory unit to process data input or output; first PCI Express expansion slots connected to the memory channel hub; an I/O channel hub connected to the memory channel hub and configured to connect various kinds of sub-devices, the I/O channel hub having a redundant array of independent disks (RAID) function block; second PCI Express expansion slots connected to the I/O channel hub; SATA ports; USB ports; peripheral devices including a ROM bios; a non-volatile storage device having an operating system installed therein, wherein an SSD doubler is inserted into any PCI Express slot of the computer system, and wherein the SSD doubler includes a printed circuit board having a series of PCI Express edge fingers; at least one bay body fastened in surface contact with the printed circuit board and configured to form a plurality of stacked unit bays; a first connector portion configured to correspond to a lower bay of the bay body; a second connector portion disposed alongside the first connector portion in a forward or backward direction and configured to correspond to an upper bay of the bay body; storage media accommodated in the bays formed by the bay body and configured to correspond to the first connector portion and the second connector portion; a first external interface port connected to the first connector portion; and a second external interface port connected to the second connector portion.

Also, the SSD doubler is inserted into at least one PCI Express slot, and external interface ports of the SSD doubler are correspondingly connected to external interface ports provided on a motherboard.

Also, the SSD doubler is logically recognized as a single storage space or a plurality of storage spaces according to RAID settings of an arbitrary chipset provided on a motherboard.

Also, the central processing unit is configured to display a graphic user interface residing on the main memory unit on a monitor, read a status register of the main memory unit, and display whether a stooge medium is present in the installed SSD doubler depending on a value of the status register.

Also, the central processing unit checks statuses of the storage media at predetermined intervals through a program residing on a system memory unit while there is no data access to the storage media, and records fault information in a fault register when it is determined that a fault has occurred in any storage medium.

Also, the central processing unit displays a graphic user interface residing on the main memory unit on a monitor to indicate an SSD doubler marked with a default status, selects one status of an SSD doubler installed in a computer among a vertical status, a horizontal status, an inverse vertical status, and an inverse horizontal status according to a user's manipulation, and displays the status in which the SSD doubler is mounted inside the computer system in order to realistically represent, through a graphic user interface, a fault having occurred in a storage medium installed in an arbitrary position while the SSD doubler having storage media installed therein is used.

Also, the central processing unit stores a mounted status of the SSD doubler finally selected from the graphic user interface in a status information register, stores the status information register in the non-volatile storage device when the computer system ends, reads a fault detection register of the main memory unit while the computer system is used, and displays a position of a faulty storage medium on an image of the SSD doubler indicating a current placement status on the graphic user interface according to the status information register when a default bit is detected.

Also, the central processing unit displays a graphic user interface residing on the main memory unit on a monitor, places, on the graphic user interface, an SSD doubler and/or an individual storage medium to which the graphic user interface is intended to be applied, and displays whether the storage medium is present and whether a fault has occurred in the storage medium in association with a status information register.

Also, the printed circuit board has a universal signal input/output IC connected to data input/output pins of the PCI Express fingers, and the central processing unit reads a fault detection register of the main memory unit and transfers a value of the read fault detection register to an SSD doubler having the universal signal input/output IC built therein when a fault has occurred.

Also, the SSD doubler has fault indication LEDs and operates a fault indication LED for a storage medium disposed at a corresponding position according to a fault detection signal output by the universal signal input/output IC.

According to still another aspect, a multi-device bay system includes an SSD doubler having a multi-interface port; a backplane board having a first connection unit correspondingly connected to the multi-interface port of the SSD doubler at a front surface; at least one PCI Express slot provided at a rear surface of the backplane board; an external interface card installed at one side of the PCI Express slot; and a RAID card installed at the other side of the PCI Express slot.

Also, the backplane board has a second connection unit composed of a plurality of connectors and correspondingly connected to the first connection unit.

Also, in the PCI Express slot, pins of a PCI Express slot connector having the external interface card are correspondingly connected to pins of a PCI Express slot connector having the RAID card.

Also, a SATA (or SATA Express or SAS) or PCI Express connection port of the RAID card provided on the PCI Express slot connector is connected to the second connection unit provided on the rear surface of the backplane board.

According to the SSD doubler of the present invention, a connection port for an external interface is extended from a single port to a plurality of ports, and the interface ports are individually and directly connected to connectors corresponding to storage media provided inside the SSD doubler.

In consideration that various RAID functions are supported for a chipset depending on a motherboard of a computer in view of the above-described characteristics, it can be expected that a series of SSDs mounted on the SSD doubler may be used as desired, by using the SSD doubler as an SSD holder that can simply mount multiple SSDs to mount two or three SSDs on one SSD doubler body, connecting each SSD to connection ports connected to a motherboard's chipset through a separate cable, and designating a RAID function in a graphic user interface (GUI) environment on the computer.

For example, when two SSDs are mounted on the SSD doubler of the present invention and the SSDs are configured in RAID0 (Stripe), the SSD doubler can provide a dual channel SATA or PCI Express interface effect by means of two cables according to an interface scheme supported by the SSDs.

### Advantageous Effects

According to a solid-state drive (SSD) doubler of the present invention, while a 3.5-inch hard disk drive type SSD doubler is limited to a maximum of three external interface ports for the purpose of performance improvement, a PCIe ADD-IN card-type SSD doubler of the present invention is capable of allowing a larger number of external interface ports and SSD support fixtures to be placed because there is no space limitation in an arrangement of external interface ports thereof.

As a result, while the 3.5-inch hard disk drive type SSD doubler can have up to three 2.5-inch SSDs with a thickness of 7 mm, the PCIe ADD-IN card-type SSD doubler can have three or six SSD bays depending on the number of SSD support fixtures having the same form and also can have six or twelve SSD bays by the SSD support fixtures being mounted in a two-layered structure. Therefore, in addition to providing a simple capacity expansion function or a disk duplication function by simply using a RAID0 (Strip) or RAID1 (Mirror) configuration, the PCIe ADD-IN card-type SSD doubler provides a RAID5 function in which a single recovery bit is generated for storage media inserted into three or more SSD bays and the recovery bit is cyclically stored together with data, and also provides a RAID6 function in which two recovery bits are generated for storage media inserted into 4 or more SSD bays and the recovery bits are cyclically stored together with data to provide a user with improved I/O performance. Furthermore, even when a fault simultaneously occurs in one or two SSDs while the SSD doubler is being used, the PCIe ADD-IN card-type SSD doubler provides an environment for recovering data by replacing the faulty SSD with a new SSD having the same capacity or more. This allows the user to expect an effect of using the SSD doubler equipped with an SSD without worrying about data loss.

### DESCRIPTION OF THE DRAWINGS

FIG. 1 shows a perspective view and a rear view of a solid-state drive (SSD) holder according to a conventional technique.

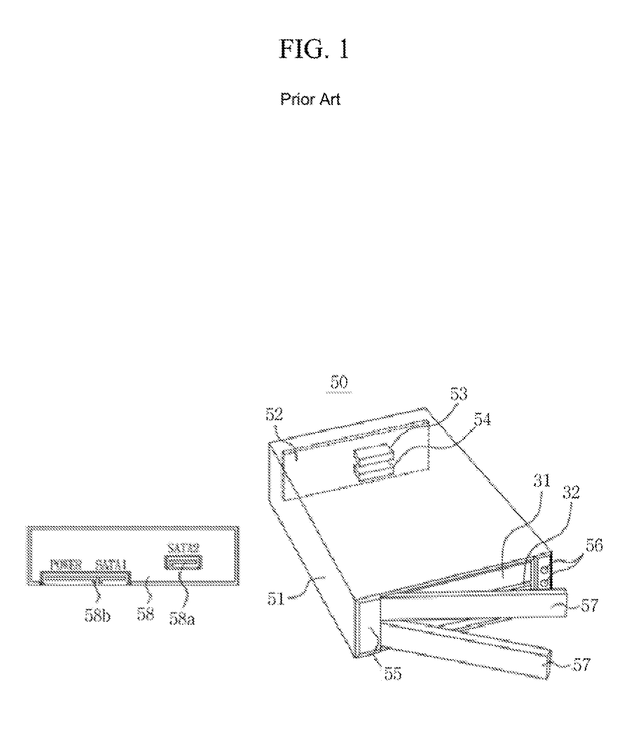

FIG. 2 is a block diagram of an SSD doubler according to a first embodiment of the present invention.

FIG. 3 is a rear perspective view of the SSD doubler according to the first embodiment of the present invention.

FIG. 4 is a plan view of an SSD doubler having the form of a PCI Express add-in card according to the first embodiment of the present invention.

FIG. 5 is a view including a front view, a plan view, and left-side and right-side views of the SSD doubler according to the first embodiment of the present invention.

FIG. 6 is a view showing an aspect in which storage media (SSDs) are coupled to the SSD doubler according to the first embodiment of the present invention.

FIG. 7 is a block diagram of an SSD doubler according to a second embodiment of the present invention.

FIG. 8 is a view showing an aspect in which storage media (SSDs) and an inner hard guide are coupled to the SSD doubler according to the second embodiment of the present invention.

FIG. 9 is a diagram showing a configuration of a multi-device bay system having the SSD doubler according to the second embodiment of the present invention.

FIG. 10 is a diagram showing a configuration of a backplane board for the multi-device bay system to which the SSD doubler is coupled according to the second embodiment of the present invention.

FIG. 11 is a block diagram of a computer system having a chipset capable of supporting a redundant array of independent disks (RAID) function built thereinto according to a third embodiment of the present invention.

FIG. 12 is a block diagram of a PCI Express card type SSD doubler according to the third embodiment of the present invention.

FIG. 13 is a structure diagram of the PCI Express card type SSD doubler according to the third embodiment of the present invention.

FIG. 14 is an enlarged perspective view of left and right bay bodies according to the third embodiment of the present invention.

FIG. 15 is a view showing a configuration of a register map of a system memory according to the third embodiment of the present invention.

### BEST MODE

Advantages and features of the present invention, and implementation methods thereof will be clarified through the following embodiments described with reference to the accompanying drawings. However, embodiments of the technical spirit of the present invention may be embodied in various forms and are not to be construed as limited to the embodiments set forth herein. Rather, these embodiments are provided so that this disclosure is thorough, complete, and fully conveys the scope of the present invention to those skilled in the art. Also, embodiments of the technical spirit of the present invention are defined only by the appended claims.

The terminology used herein is for the purpose of describing particular embodiments only and is not intended to be limiting of the present invention. As used herein, the singular forms “a,” “an,” and “the” are intended to include the plural forms as well, unless the context clearly indicates otherwise.

It should be further understood that the terms “comprises,” “comprising,” “includes,” “including,” and/or “having,” when used in this specification, specify the presence of stated features, integers, steps, operations, elements, components, or groups thereof, but do not preclude the presence or addition of one or more other features, integers, steps, operations, elements, components, or groups thereof.

Additionally, the embodiments in the detailed description will be described with reference to sectional views and/or plan views as ideal exemplary views of the present invention. In the figures, the dimensions of layers and regions are exaggerated for clarity of illustration. Accordingly, shapes of the exemplary views may be modified according to manufacturing techniques and/or allowable tolerances. Therefore, the embodiments of the present invention are not limited to the specific forms shown, but may include changes in form that are generated or needed during the manufacturing process. For example, a region illustrated as a rectangle may be rounded or have a predetermined curvature. Therefore, the regions illustrated in the drawings have schematic properties, and the shapes of the regions illustrated in the drawings are illustrative of specific shapes of regions of a device and are not intended to limit the scope of the present invention.

Like reference numerals refer to like elements throughout. Therefore, although like reference numerals or similar reference numerals are not mentioned or described in the drawing, it should be described with reference to the other drawings. Furthermore, although reference numerals are not illustrated, the reference numbers are described with reference to the other drawings.

Hereinafter, embodiments of the present invention will be described.

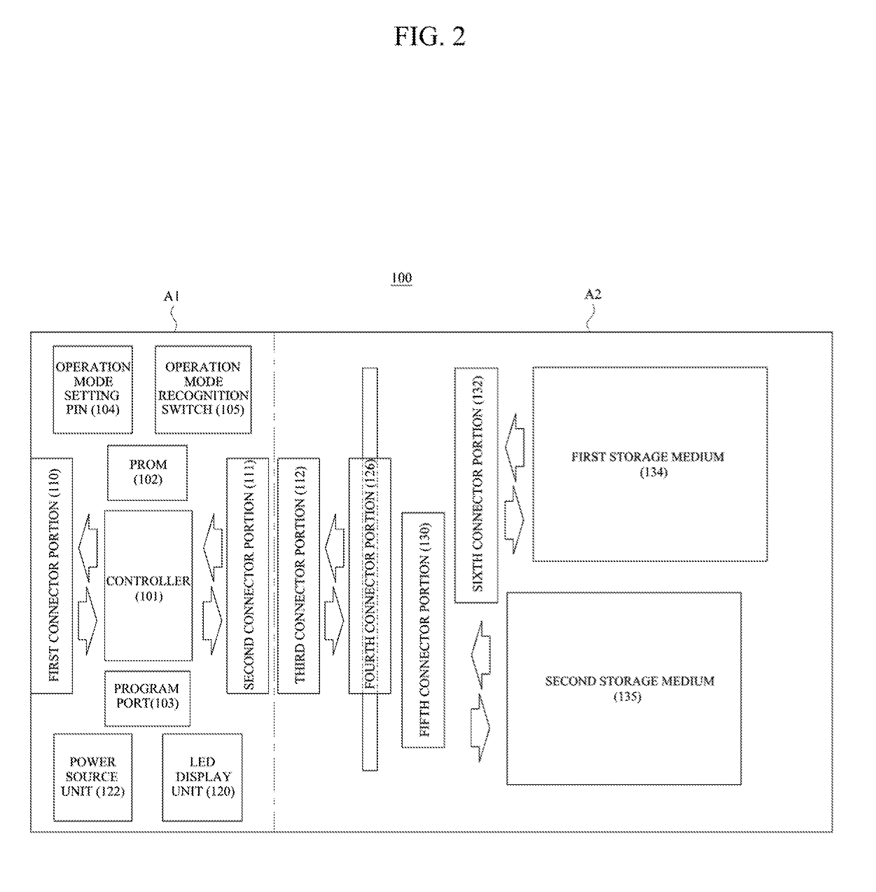

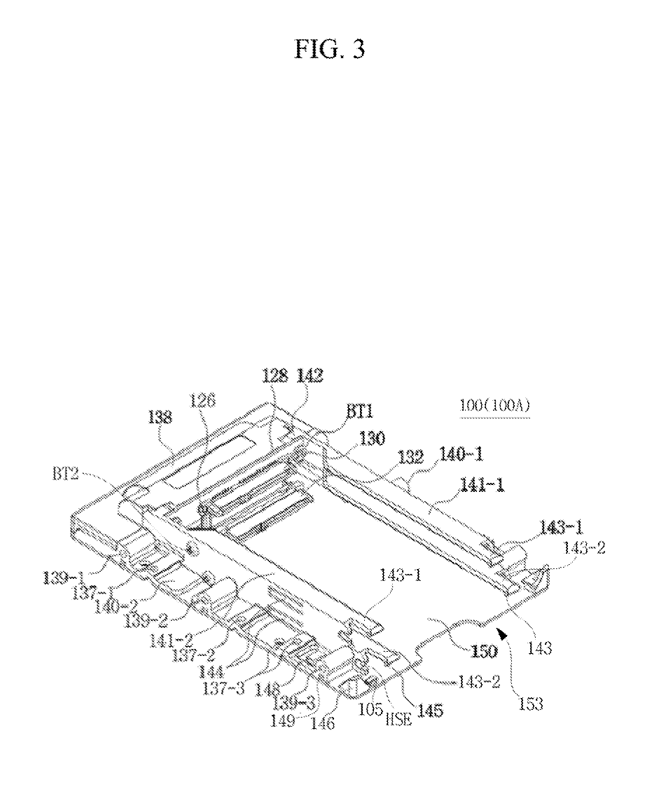

FIG. 2 is a block diagram of a solid-state drive (SSD) doubler 100 according to a first embodiment of the present invention, and FIG. 3 is a rear perspective view of the SSD doubler according to the first embodiment of the present invention. The SSD doubler 100 may largely have two areas, that is, a controller area A1 and a bay configuration area A2.

The controller area A1 is composed of unit blocks such as a first connector portion 110 corresponding to an external interface; a controller 101, which is a System-on-Chip (SoC) integrated circuit (IC), connected to the first connector portion 110 through a high-speed serial differential signal; a programmable read-only memory (PROM) 102 having an operation program for the controller 101 stored therein; a program port 103 provided to directly program the external PROM 102; an operation mode setting pin 104 connected to the controller 101 and configured to predetermine which redundant array of independent disks (RAID) function the controller should perform; a operation mode recognition switch 105 configured to enable the controller 101 to recognize a setting status determined by the operation mode setting pin 104; a light-emitting diode (LED) display 120 configured to monitor various kinds of operation statuses of the controller 101; and a power source unit 122 configured to receive externally input power from the first connector portion 110 and generate various kinds of power to be used inside the SSD doubler 100.

The bay configuration area A2 is composed of a sixth connector portion 132 configured to connect a first storage medium 134 inserted thereinto to the controller 101; a fourth connector portion 126 configured to connect a second storage medium 135 inserted thereinto to the controller 101, and bay bodies 140-1 and 140-2 guided to the sixth connector portion 132 and the fourth connector portion 126 to form bays when the first storage medium 134 and the second storage medium 135 are inserted.

However, the fourth connector portion 126 corresponding to a storage medium connected through an upper portion of the bay bodies 140-1 and 140-2 may not correspond to one connector portion, unlike the sixth connector portion 132 located at a lower portion thereof. In this case, the above problem may be solved by providing the fourth connector portion 126 above or below a printed circuit board 150, inserting a separate vertical connection board 128 having an edge finger corresponding to an internal pin of the fourth connector portion 126 into the fourth connector portion 126, and placing a fifth connector portion 130 disposed vertically to one side of the vertical connection board 128 to correspond to an upper bay of the bay bodies 140-1 and 140-2.

The controller area A1 and the bay configuration area A2 have been described as being separated to distinguish functional blocks for convenience of description. However, when the two areas A1 and A2 are actually separated from each other, the two areas separated into separate boards may be naturally combined by a second connector portion 111 for connecting to the bay configuration area A2 to the controller area A1 and a third connector portion 112 for connecting to the controller area A1 to the bay configuration area A2 being provided, and signal mapping being performed such that connection pins of both of the connector portions correspond to each other.

In this case, a printed circuit board 150 of the controller area A1 and the printed circuit board 150 of the bay configuration area A2 may be integrated by the second connector portion 111 to the third connector portion 112 being coupled, and a bottom surface of each of the printed circuit boards 150 may be firmly coupled to the bay bodies 140-1 and 140-2 through a coupling hole included in the bay bodies 140-1 and 140-2 by means of a coupling unit such as a bolt.

As described above, the controller area A1 and the bay configuration area A2 are separately provided and then coupled to each other to form the entire functional block. This is because none of the elements disposed in the bay configuration area A2 are affected by replacement of the elements constituting the controller area A1.

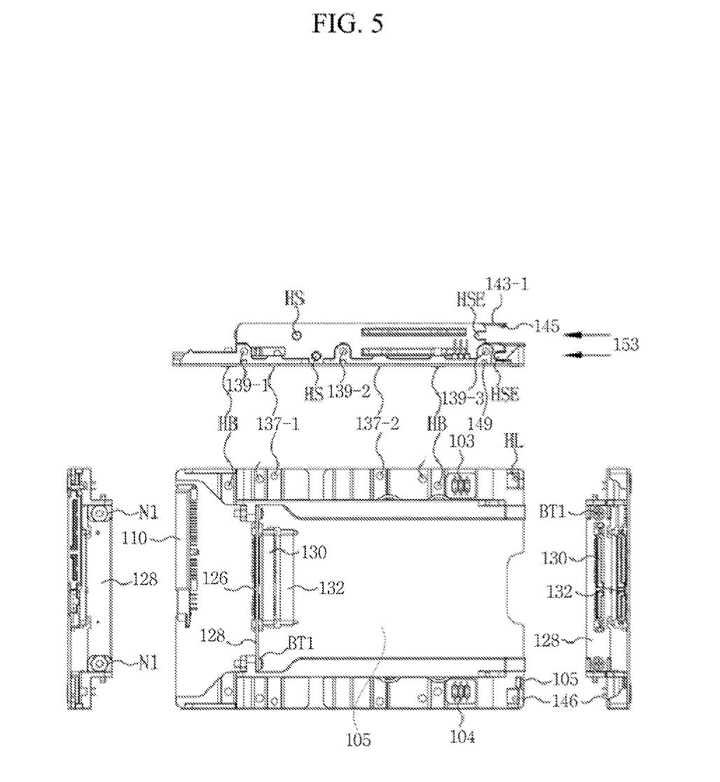

As an example, when connectors of the first connector portion 110 connected through an external interface of the controller area A1 are located at the same position as that of an interface connector of a 3.5-inch hard disk drive (HDD), the SSD doubler 100 according to the first embodiment of the present invention may be used instead of the 3.5-inch HDD. However, when the replacement is performed with an add-in card 70 in which the connectors of the first connector portion 110 corresponding to the 3.5-inch HDD are arranged in the form of edge fingers 73 to correspond to a PCI Express slot (not shown), as shown in FIG. 5, an SSD doubler having the form of a PCI Express add-in card may be used.

Although the appearance is different, the controller area A1 and the bay configuration area A2 may be coupled by the second connector portion 111 and the third connector portion 112, which are provided to the controller area A1 and the bay configuration area A2, respectively, being provided, or may be formed in one body from which the second connector portion 111 and the third connector portion 112 is removed.

However, the controller 101 should function to support a Serial Advanced Technology Attachment (SATA) (or SATA Express or SAS) interface input/output when the controller area A1 has a form corresponding to that of the connector of the 3.5-inch HDD, and the controller 101 should function to support a PCI Express interface input/output when the controller area A1 has a form corresponding to that of a PCI Express slot.

However, while the above-described elements are previously placed and wired on the printed circuit board 150 to correspond to any storage media for supporting a SATA (or SATA express or SAS) interface and a PCI Express interface by means of a separate connector (not shown), the first storage medium 134 and the second storage medium 135 connected from the controller 101 thereto through the sixth connector portion 132 and the fourth connector portion 126 via the second connector portion 111 and the third connector portion 112 may be adaptively used regardless of an interface supported by the controller 101 reflected in the controller area A1.

When the number of bays provided by one of the bay bodies 140-1 and 140-2 is two, the first storage medium 134 and the second storage medium 135 may be connected. In this case, regardless of the type of the interface of the first connector portion 110 used as the external interface, the controller 101 according to the first embodiment of the present invention supports RAID operation modes such as RAID0 (STRIPE), RAID1 (MIRROR), SPAN, or a mode in which individual storage media are separately shown.

However, a RAID operation mode in which the controller 101 is to operate is selected from among the RAID operation modes according to a setting status of the operation mode setting pin 104. When a user presses the operation mode recognition switch 105 while power is input to the SSD doubler 100, the controller 101 recognize the RAID operation mode.

The recognized RAID operation mode is stored in an address area designated in the external PROM 102. Whenever power is on, the controller 101 reads and recognizes a RAID operation mode setting value stored in the address area designated in the PROM 102. Accordingly, there is no need to press the operation mode recognition switch 105 whenever power is on.

However, whether the above-described bay bodies 140-1 and 140-2 can form bays for SSDs or any other equivalent storage media inserted from the outside in the SSD doubler 100 and whether the storage media can be inserted into and stably connected to the fifth connector portion 130 and the sixth connector portion 132 will be described below with reference to FIG. 3.

First, the bay bodies 140-1 and 140-2 are horizontally widened according to a width of an SSD to form bays. With respect to the drawing, the right bay body 140-1 and the left bay body 140-2 have a right bay guide bar 141-1 and a left bay guide bar 141-2 for forming the bays at a middle portion and an upper portion, respectively.

The bay bodies 140-1 and 140-2 may be formed as separate parts and may form an integrated bay body in which lower surfaces of the right bay body 140-1 and the left bay body 140-2 are connected such that the lower surfaces are adequately thin.

As another method of forming the integrated bay body, vertical connection board fastening protrusions 142 included in the right bay body 140-1 and the left bay body 140-2 may be integrated with and connected to each other. A durable integrated bay body may be formed by a combination of the connection between the lower surfaces and the connection between the vertical connection board fastening protrusions 142.

A connector included in the sixth connector portion 132 corresponding to an interface connector (not shown) included in the first storage medium 134, which is inserted into a lower bay through a storage medium entrance 153, is directly soldered on an upper surface of the printed circuit board 150, and a connector included in the fifth connector portion 130 corresponding to an interface connector (not shown) included in the second storage medium 135, which is inserted into an upper bay, is disposed a certain distance from the sixth connector portion 132 in parallel therewith at a corresponding position of the vertical connection board 128.

The vertical connection board 128 is located between the controller 101 and the connector included in the sixth connector portion 132 and is inserted into a connector included in the fourth connector portion 126, which is provided adjacent to the sixth connector portion 132 vertically to the printed circuit board 150.

The vertical connection board 128 inserted into the fourth connector portion 126 is fixed to a nut (not shown) by means of a fastening bolt BT1 passing through through-holes included in the vertical connection board fastening protrusions 142 provided in the right bay body 140-1 and the left bay body 140-2.

The shape of the bay bodies 140-1 and 140-2 used in the SSD doubler 100 according to the first embodiment of the present invention will be described in detail below with reference to the front view, the plan view, the left-side view, and the right-side view of FIG. 5 corresponding to the perspective view of FIG. 3.

First, when the first and second storage media 134 and 135 are inserted into bays formed by the bay guide bars 141-1 and 141-2 included in the bay bodies 140-1 and 140-2 and then connected to the sixth connector portion 132 and the fifth connector portion 130, respectively, the first storage medium 134 and the second storage medium 135 may be fastened to the left and right sides of the bay bodies 140-1 and 1402 by separate fastening bolts BT2 being inserted into holes HS corresponding to fastening holes included in the side surfaces of the first and second storage media 134 and 135 in order to prevent the inserted first and second storage media 134 and 135 from laterally moving and firmly fasten the inserted first and second storage media 134 and 135.

However, when it is necessary to remove any one of the first and second storage media 134 and 135 while the SSD doubler 100 is mounted in a system (not shown) capable of being equipped with the SSD doubler 100, it is difficult to release the fastened bolts BT2 to remove the storage media 134 and 135 as long as the SSD doubler 100 is not separated from a main body of the system.

In order to solve such a problem, the SSD doubler 100 according to the first embodiment of the present invention may have a side holder 144 branching from the bay bodies 140-1 and 140-2 at center portions of the bays formed by the bay bodies 140-2 and 140-2 to enable the first and second storage media 134 and 135 to maintain a current mounted status without lateral movement by means of elasticity being applied by an inward protruding surface of the side holder 44 to push the first and second storage media 134 and 135 inward from the left and right sides.

In addition, it is possible to structurally prevent the first and second storage media 134 and 135 from being removed toward the outside of the storage medium entrance by forming elastic guide bars 143-1 and 143-2 that protrude in an installation direction of the storage media from the bay guide bars 141-1 and 141-2 protruding from the bay bodies 140-1 and 140-2 and by enabling storage medium supporting protrusions 145 disposed at the ends of the elastic guide bars 143-1 and 143-2 to always vertically push the first and second storage media 134 and 135 having the storage medium supporting protrusions 145 installed therein by means of elasticity of the elastic guide bars 143-1 and 143-2 due to a property of a material (e.g., polycarbonate) of which the bay bodies 140-1 and 140-2 are made.

When a user wants to remove the first and second storage media 134 and 135 installed in the bay bodies 140-1 and 140-2 of the SSD doubler 100, a structure for moving the elastic guide bars 143-1 and 143-2 protruding from the bay bodies 140-1 and 140-2 inward, exposing the first and second storage media 134 and 135 to the outside of the elastic guide bars 143-1 and 143-2, and enabling the user to separate the first and second storage media 134 and 135 by pulling both sides of the exposed first and second storage media 134 and 135 is provided to allow the first and second storage media 134 and 135 to be easily separated from the bay bodies 140-1 and 140-2.

However, when connection pins built into the fifth connector portion 130 and the sixth connector portion 132 coupled to the first and second storage media 134 and 135 by physical contact have high elasticity, the first and second storage media 134 and 135 connected to the fifth connector portion 130 and the sixth connector portion 132 through the bays formed by the bay bodies 140-1 and 140-2 may tend not to be easily disconnected from the fifth and sixth connector portions 130 and 132 even though a user pulls the storage media exposed at an entrance with his or her fingers.

In this case, it is possible to easily separate the installed first and second storage media 134 and 135 from the bay bodies 140-1 and 140-2 by inserting both ends of a partially inwardly recessed “⊏”-shaped jig (not shown) into the fastening holes of the storage media through a “U”-shaped horizontal storage medium fastening/removing hole HSE provided in a direction toward the storage medium entrance to remove the storage media (SSDs) and then pulling the jig in a direction receding from the storage medium entrance.

Meanwhile, various kinds of concave-convex grooves and holes are provided in a main body of the bay bodies 140-1 and 140-2. In the block diagram, the operation mode setting pin 104 and the program port 103 are present in the controller area A1. However, the operation mode setting pin 104 and the program port 103 are actually provided on the printed circuit board 150 exposed through a rectangular through-hole disposed at outer lower portions of the bay bodies 140-1 and 140-2 close to the storage medium entrance 153 for convenience of operation.

The holes HS, which are through-holes through which the fastening holes provided at both sides of the first and second storage media 134 and 135 when the first and second storage media 134 and 135 are inserted into the bay bodies 140-1 and 140-2 to correspond to the fifth connector portion 130 and the sixth connector portion 132, are used by a user to firmly fasten the first and second storage media 134 and 135 by means of a separate fastening unit such as the bolt BT2.

Holes 137-1 and 137-2 are fastening holes corresponding to four fastening holes provided on a lower surface of a 3.5-inch HDD.

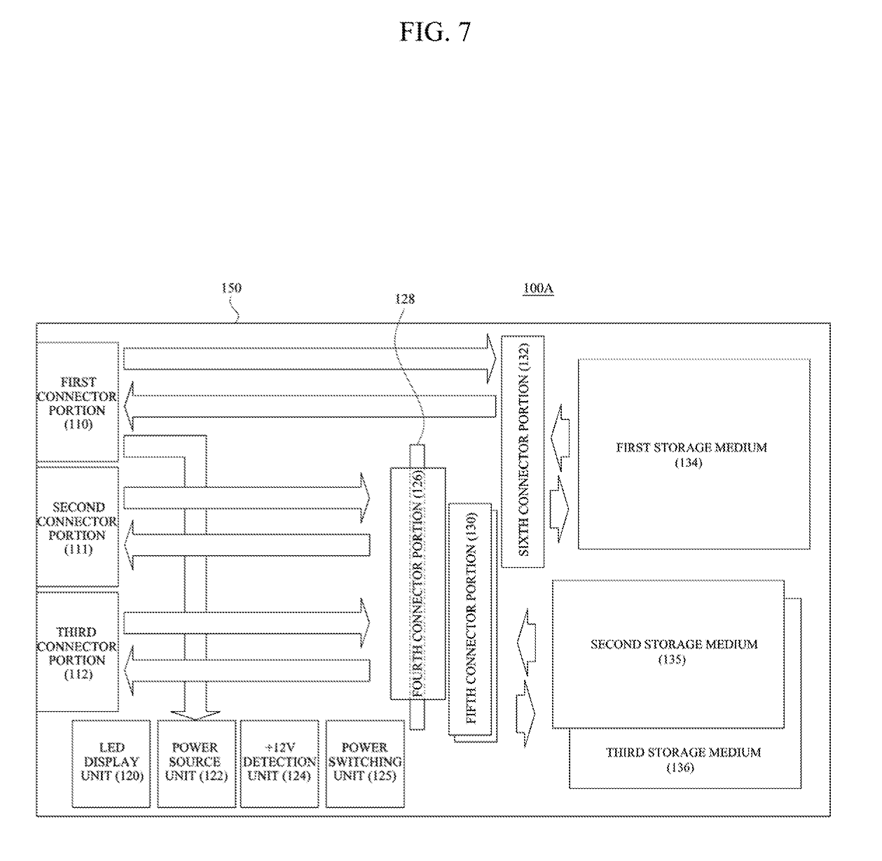

Holes 139-1, 139-2, and 139-3, which are holes reflecting physical positions of the fastening holes provided at both sides of the 3.5-inch HDD, are used to correspond to a unit for mounting the HDD and utilized to fasten a hard guide 154 illustrated in FIG. 7.

The hole HL is a hole for fastening a handle-combined LED light guide plate 146 for indirectly exposing some LEDs included in the LED display unit 120.

Such handle-combined LED light guide plates 45 and 46 each have an inner lower portion with a “¬”-shaped sectional surface. An active (blue) LED and a fault (red) LED for the upper and lower storage media (SSDs), which are some LEDs included in the LED display unit 120, are disposed at an upper corner and a lower corner of the LED display unit 120.

Meanwhile, a global activity (pure green) LED is disposed on the printed circuit board 150 inside a concave-convex hole 149 provided at the lower surface of the right bay body 140-1, and a power (green) LED is disposed on the printed circuit board 150 inside a concave-convex hole 149 provided at the lower surface of the left bay body 140-2.

As shown in FIG. 5, a general hexagonal nut is used as a nut N1 for fastening the vertical connection board 128. When the fastening bolt BT1 is tightly inserted into the nut N1 through a through-hole provided in the vertical connection board fastening protrusion 142 by means of a tool such as a screw driver, one sectional surface of the hexagonal nut N1 is brought into surface contact with inner side surface of the bay bodies 140-1 and 140-2 adjacent to the vertical connection board fastening protrusion 142. Thus, it is possible to enhance a product assembling property by preventing the nut N1 from spinning without traction.

For convenience of operation, the operation mode recognition switch 105 is disposed in an empty side space of an end surface of the printed circuit board 150 disposed under the storage medium entrance 153.

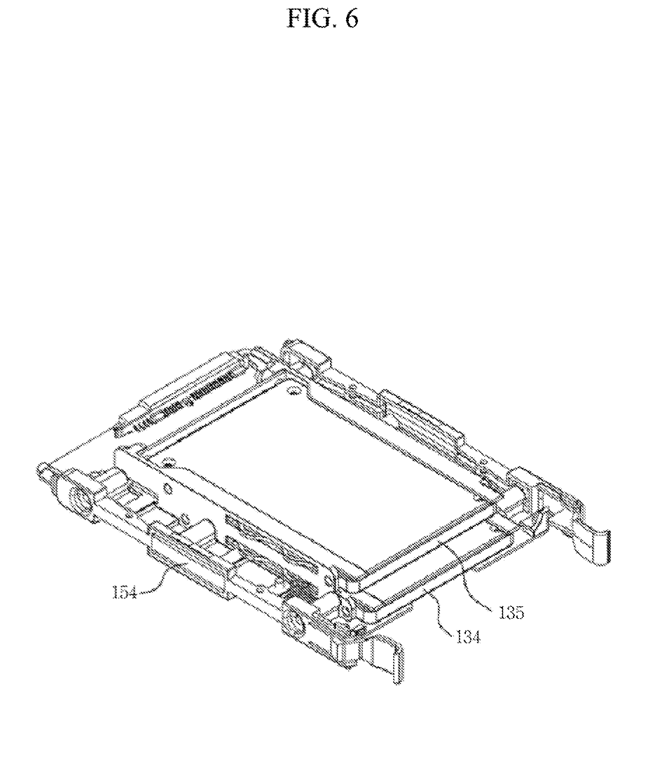

FIG. 6 shows an aspect in which storage media (SSDs) are coupled to the SSD doubler 100 according to the first embodiment of the present invention, and shows a case in which the hard guide 154 is also coupled to the hard connection holes 139-1, 139-2, and 139-3 while the storage media 134 and 135 are inserted into the upper and lower bays formed in the bay bodies 140-1 and 140-2.

FIG. 6 shows an example in which the first and second storage media 134 and 135 are coupled to the bay bodies 140-1 and 140-2 corresponding to a specification for a widely used common storage medium (SSD) with a thickness of 7 mm.

However, some old-fashioned storage media (SSDs) or enterprise-class mass storage media (SSDs) having the same width and length as those of a standard 7-mm storage medium (SSD) but having a thickness greater than that of a 7-mm storage medium (SSD) have been released.

Also, even a 2.5-in HDD may have the same width and length as those of a standard 7-mm storage medium (SSD) but may have a thickness of about 9.5 mm or about 10 mm.

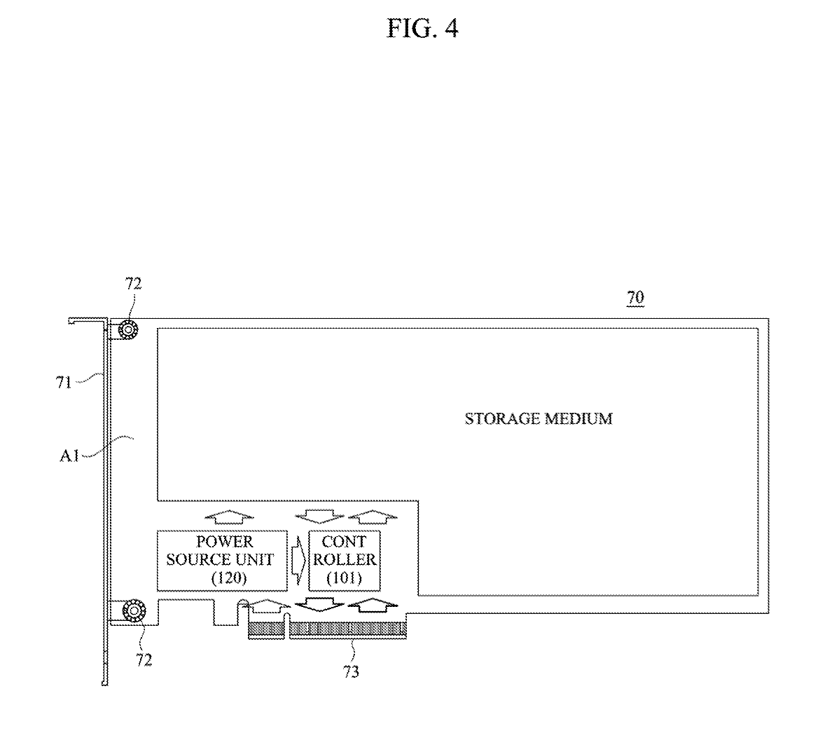

FIG. 4 is a plan view of the SSD doubler 100 having the form of a PCI Express add-in card 70. The PCI Express edge finger 73 is disposed at a lower portion of the PCI Express add-in card 70 instead of the first connector portion 110 for an external interface, and the controller area A1 is provided on the printed circuit board 150 that is exposed to a space formed between a PCI Express add-in card bracket 71 located at a left portion and the vertical connection board 128 of the bay bodies 140-1 and 140-2.

The PCI Express add-in card bracket 71 is fastened to the printed circuit board 150 through bracket fastening holes 72 that are symmetrically disposed in a vertical direction.

The SSD doubler 100 is illustrated as having only one pair of bay bodies 140-1 and 140-2 mounted on the PCI Express add-in card 70. However, it is possible to propose various SSD doublers 100 according to a method of placing and stacking the bay bodies 140-1 and 140-2.

The SSD doubler 100 according to the first embodiment of the present invention includes the following examples. As a first example for accommodating four storage media, the bay bodies 140-1 and 140-2 shown in FIG. 4 are disposed to face each other such that the storage medium entrance 153 faces the outside, and then several functional blocks of the controller area A1 are disposed in an exposed space formed therebetween. As a second example for accommodating four storage media, one pair of bay bodies 140-1 and 140-2 having the same external dimensions are additionally stacked, and the vertical connection board 128 is extended to correspond to the fifth and sixth connector portions 130 and 132 to connect the fifth and sixth connector portions 130 to the pair of bay bodies 140-1 and 140-2 such that a signal connection to the fifth and sixth connector portions 130 and 132 of the bay bodies 140-1 and 140-2 connected to the controller 101 is made through a separate wire and not through a common wire. As a third example, the bay bodies 140-1 and 140-2 disposed to face each other in parallel at an upper portion in the first case are symmetrically disposed at the lower portion of the printed circuit board 150. As a fourth example, the bay bodies 140-1 and 140-2 disposed above and below the printed circuit board 150 in the third example are vertically stacked two times, as described in the second example, to install a total of 16 storage media.

When the number of bay bodies 140-1 and 140-2 increases and the number of storage media installed therein increases, it is preferable for the controller 101 to support RAID3, RAID5, and RAID6 as RAID operation modes that are expanded over comparatively simple function RAID modes, which are classified into RAID0, RAID1, SPAN, and individual storage media, and also should support expansive RAID functions such as RAID10, RAID50, and RAID60 as a combination of RAID3, RAID5, and RAID6.

### MODE OF THE INVENTION

FIGS. 7 to 10 relate to a solid-state drive (SSD) doubler 110A having a multi-interface port and a multi-device bay system using the same according to a second embodiment of the present invention. The same elements as those shown in FIGS. 2 to 6, which are associated with the first embodiment of the present invention, are denoted with the same numerals, and redundant descriptions thereof will be omitted.

The second embodiment of the present invention is designed in consideration of the fact that, although a controller 101 is installed in a SSD doubler 100 to provide various RAID-related functions in a first embodiment of the present invention, there is a limit to the improvement of operation performance because a single-port external interface is provided.

That is, by replacing a RAID function provided by a chipset of a recent computer motherboard with a function of the SSD doubler 100 according to the first embodiment of the present invention and by including an additional interface point to form multiple channels through a multi-interface point in terms of the operation performance beyond formation of a signal channel through a single-interface point, it is possible to improve operation performance.

To this end, the SSD doubler 100A according to the second embodiment of the present invention is formed by a second connector portion 111 and a third connector portion 112 that are additionally disposed next to a first connector portion 110, which is provided as a default external interface port, being added to the SSD doubler 100 according to the first embodiment of the present invention to increase the number of external interface channels. The interface channels are provided inside the SSD doubler 100A according to the second embodiment of the present invention, and a storage medium inserted into the SSD doubler from the outside is connected to a plurality of connectors equal to the number of external interface channels.

The SSD doubler 100A according to the second embodiment of the present invention receives power from power pins of a connector included the first connector portion 110, which is the default external interface port and connects the power to a power source unit and a power switching unit included therein. When +12V external power is supplied to the SSD doubler, the power source unit generates +5V power through a DC-to-DC power conversion circuit using +12V as input power.

The power switching unit determines that a power source of +5V power is supplied to the installed storage medium depending on whether +12V power voltage is detected.

By allowing operation status monitoring signals output from installed external storage media to be obtained as a logical disjunction result by the LED display unit and output to the first connector portion provided as a default interface port, or by connecting the signals except for an operation monitoring signal for the storage medium connected to the first connector portion to light-emitting diodes (LEDs) corresponding to individual storage media and enabling the LEDs to be turned on/off, the operation monitoring signals for the remaining storage media may be output.

Thus, the SSD doubler 100A according to the second embodiment of the present invention may include a multi-interface point, and a multi-device bay system equipped with the SSD doubler 100A may include a series of connection units corresponding to multi-interface ports. Thus, it is also possible to provide a multi-device bay system having operation performance which is improved by a backplane board of a multi-device bay system that additionally includes a series of photo transistors (photo TR) for receiving operation monitoring signals output from storage media corresponding to the interface points other than the default interface port in the form of LED ON/OFF, and converting the received operation monitoring signals into electrical ON/OFF signals.

This will be described below in detail with reference to the accompanying drawings.

First, the SSD doubler 100A according to the second embodiment of the present invention is formed by the second connector portion 111 and the third connector portion 112 that are additionally disposed next to the first connector portion 110, which is provided as the default external interface port, being added to the SSD doubler 100 according to the first embodiment of the present invention to increase the number of external interface channels. The interface channels are provided inside the SSD doubler 100A, and a storage medium inserted into the SSD doubler from the outside is connected to a plurality of connectors equal to the number of external interface channels.

That is, the SSD doubler 100 according to the first embodiment of the present invention includes an external interface point at the same position as that of a 3.5-in hard disk drive, and includes fastening holes at side surfaces and a lower surface in terms of an external appearance thereof. While the externally mounted SSD doubler 100 is guided by bay guide bars 141-1 and 141-2 provided at left and right sides, the SSD doubler 100 is coupled to a fifth connector portion 130 through signal wires connected to a sixth connector portion 132, a fourth connector portion 126, a vertical connection board 128, and the fifth connector portion 130 provided on a printed circuit board 150 in a bay configuration area A2.

However, the SSD doubler 100 according to the first embodiment of the present invention has a structure in which an external interface port is limited to only the first connector portion 110 provided on a printed circuit board 150 in a controller area A1 and in which storage media SSDs inserted into the SSD doubler from the outside are connected through the controller 101 connected to the first connector portion 110. There is a problem in that operation of the external interface port of the first connector portion 110 is limited after one channel is formed even in a redundant array of independent disks (RAID) operation mode to improve operation performance, and the second embodiment of the present invention is intended to solve this problem.

While the SSD doubler 100 according to the first embodiment of the present invention has an external interface port composed of only one first connector portion 110, the SSD doubler 100A according to the second embodiment of the present invention has the first connector portion 110 and the second connector portion 111 and further has the third connector portion 112 to increase the number of external interface ports depending on cases.

As shown in FIGS. 3 and 7, the SSD doubler 100A according to the second embodiment of the present invention has a front cover 138 formed according to an outer appearance of connectors constituting the first, second, and third connector portions 110, 111, and 112 for the external interface ports and configured to firmly support the connectors. The front cover 138 is fastened to bay bodies 140-1 and 140-2 at left and right sides thereof by means of a separate fastening bolt BT1 and is also firmly fastened to the printed circuit board 150 at a lower portion by means of a separate bolt (not shown).

In the SSD doubler 100A according to the second embodiment of the present invention, interface signals input/output through the first connector portion 110 corresponding to a default external connection port are connected to corresponding pins of the sixth connector portion 132 that is disposed horizontally in parallel with the printed circuit board 150, and interface signals input/output through the second connector portion 111 or the third connector portion 112 corresponding to an additional interface port are connected to corresponding pins of the fourth connector portion 126. Generally, any one of Serial Advanced Technology Attachment (SATA), SAS, and SFF-8639 connectors (not shown) may be selectively used as the fourth connector portion 126.

Here, when an SAS connector or an SFF-8639 connector is used as the fourth connector portion 126, the connector may have a relatively large number of signal interface pins by default, and thus there is no problem in mapping the interface signals connected to the second and third connector portions 111 and 112 to the signal interface pins. However, when a SATA connector having a relatively small number of connection pins is used as the fourth connector portion, the interface signals may be mapped without interruption by +3.3V power pins and adjacent ground pins, which are not used by an externally inserted storage medium, being replaced with interface signal connection pins.

The fourth connector portion 126 is vertically placed on the printed circuit board 150. The vertical connection board 128 in which edge fingers 73 are arranged at a lower portion as shown in FIG. 3 is inserted into the center of the fourth connector portion 126. The fifth connector portion 130 composed of a plurality of connectors into which a second storage medium 135 and a third storage medium 136 are inserted is provided vertically to the vertical connection board 128.

+12V power, which is one of different levels of external power received from power pins provided at one side of the first connector portion 110 configured as the default interface point, may be applied to a power source unit 122 included in the SSD doubler 100A according to the present invention and used to generate +3.3V power for driving an LED display unit 120. +5V power received from the first connector portion 110 may be used to operate an internal logic device instead of the generated +3.3V power.

The power pins of the first connector portion 110 are connected to power pins of the sixth connector portion 132 and the fourth connector portion 126 to which the first storage medium 134 is connected to correspond therewith, and the power pins of the first connector portion 110 are also connected to power pins of connectors which are included in the vertical connection board 128 coupled to the fourth connector portion 126 and to which the second storage medium 135 and a third storage medium 136 are coupled to correspond thereto.

As described above, the SSD doubler 100A according to the second embodiment of the present invention is significantly different from the SSD doubler 100 according to the first embodiment of the present invention in that the SSD doubler 100 according to the first embodiment has a structure in which the SSD doubler 100 is connected to the controller 101 through a single-port interface channel established by the first connector portion 110 used as an external interface port and in which the externally inserted storage media 134 and 135 are connected to the controller 101 through a series of connectors as the SSD doubler 100A according to the second embodiment of the present invention includes the first connector portion 110 as the default interface port without the controller 101 being used and further includes the second connector portion 111 and the third connector portion 112 so that interface channels corresponding to the number of interface ports are directly connected to the externally inserted storage media 134, 135, and 136 through the above-described series of connectors.

Accordingly, since the SSD doubler 100 according to the first embodiment of the present invention internally includes the controller 101, operation modes such as RAID0 (Stripe), RAID1 (Mirror), JOBD (Span), and CLONE (Re-duplication) may be provided by the operation mode setting pin 104 and the operation mode recognition switch 105 as their own RAID-related functions.

However, the SSD doubler 100 according to the first embodiment of the present invention has an external interface port limited to a single channel and thus does not externally show operation performance of 6 Gbps or higher SATA even in the RAID0 operation mode under a 6 Gbps SATA environment. The SSD doubler 100A according to the second embodiment of the present invention may enable storage media mapped according to the number of added ports to show their operation performance by a factor of two or three depending on the number of interface channels that is increased according to the number of added ports in the RAID0 operation mode on the basis of the RAID function, which was substituted for the controller 101, being implemented by a chipset (not shown) of a connected computer motherboard or by a connected RAID card.

Meanwhile, operation monitoring signals output from the storage media 134, 135, and 136 mounted on the SSD doubler 100A according to the second embodiment of the present invention may be input to a logical conjunction element of an AND gate included in the LED display unit 120, connected to a corresponding pin of the first connector portion 110 configured as the default interface port, and output as a merged operation monitoring signal.

However, when a user performs setting through a user setting unit 148 such as a dip switch or a jumper so that an output LED light signal may be delivered to an individual corresponding interface port through an opening hole provided on a lower surface of the bay bodies 140-1 and 140-2 shown in FIG. 3, the LED display unit 120 delivers an operation monitoring signal of a corresponding storage medium to the outside by an LED ON/OFF operation in the form of an optical signal by means of LEDs disposed adjacent to and in parallel with the second connector portion 111 and the third connector portion 112 for the additional interface ports.

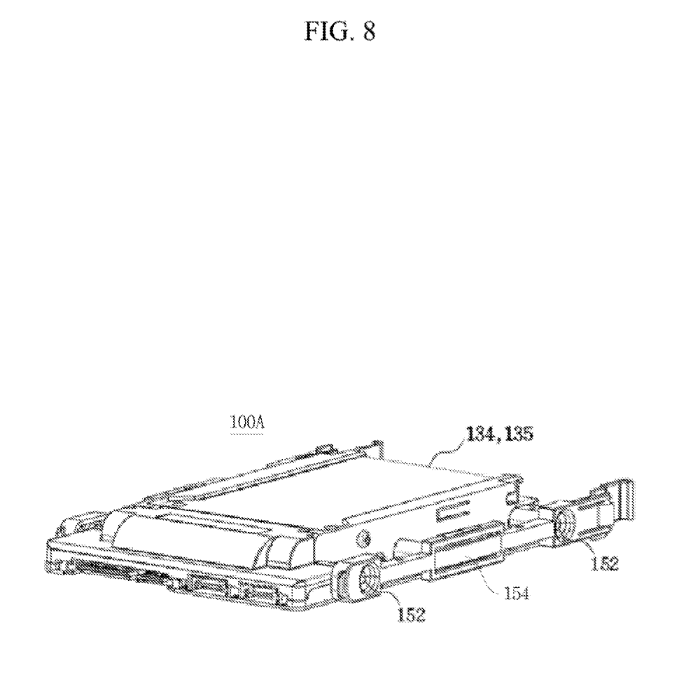

FIG. 8 is a view showing an aspect in which the storage media 134 and 135 and an inner hard guide 154 are coupled to the SSD doubler 100A according to the second embodiment of the present invention. The inner hard guide 154 is coupled to hard guide fastening holes 139-1 and 139-3 shown in FIG. 3 by means of corresponding fastening holes 152 of the inner hard guide 154.

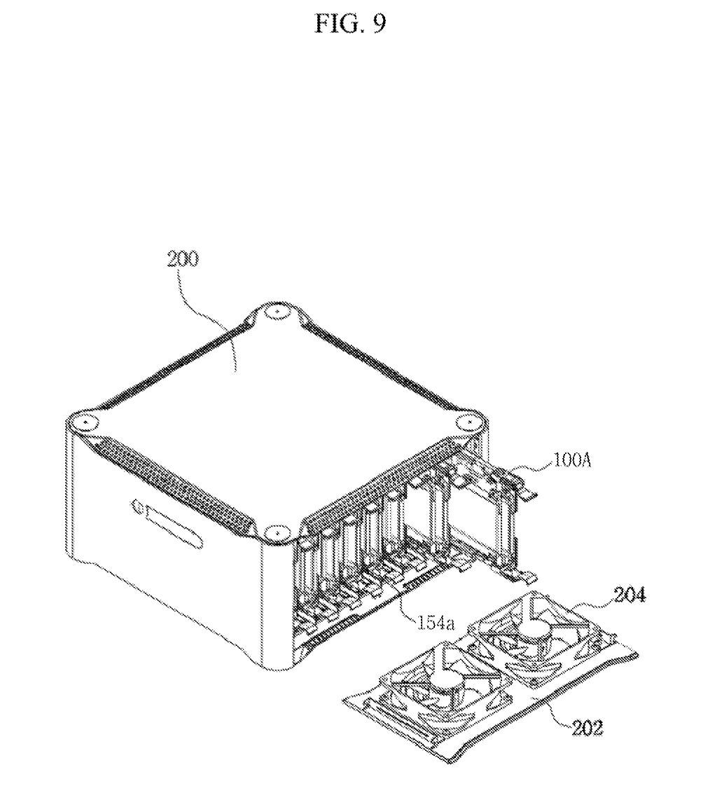

FIG. 9 is a diagram showing a configuration of a multi-device bay system 200 having the SSD doubler 100A according to the second embodiment of the present invention. Referring to FIG. 8, the SSD doubler 100A to which the storage media 134 and 135 and the inner hard guide 154 are coupled is inserted into an external hard guide 154a vertically provided in the multi-device bay system 200.

When the SSD doubler 100A according to the second embodiment of the present invention is inserted into the multi-device bay system 200, a fan cover 202 is closed. An air flow formed by a cooling fan 204 cools the storage media 134, 135, and 136 inserted into the SSD doubler 100A while passing through various vent holes formed in the SSD doubler 100A according to the second embodiment of the present invention.

The vent holes provided in the SSD doubler 100A according to the second embodiment of the present invention may be gaps that are formed between the storage media due to bay guide bars 141-1 and 141-2 branching from the bay bodies 140-1 and 140-2 or may be composed of vent holes provided on side surfaces of the bay bodies 140-1 and 140-2, a space between the first connector portion 110 and the second connector portion 111 which are formed as external interface connection ports, a space between the second connector portion 111 and the third connector portion 112, and holes formed between a boundary surface of the front cover 138 and the connector portions 110, 111, and 112.

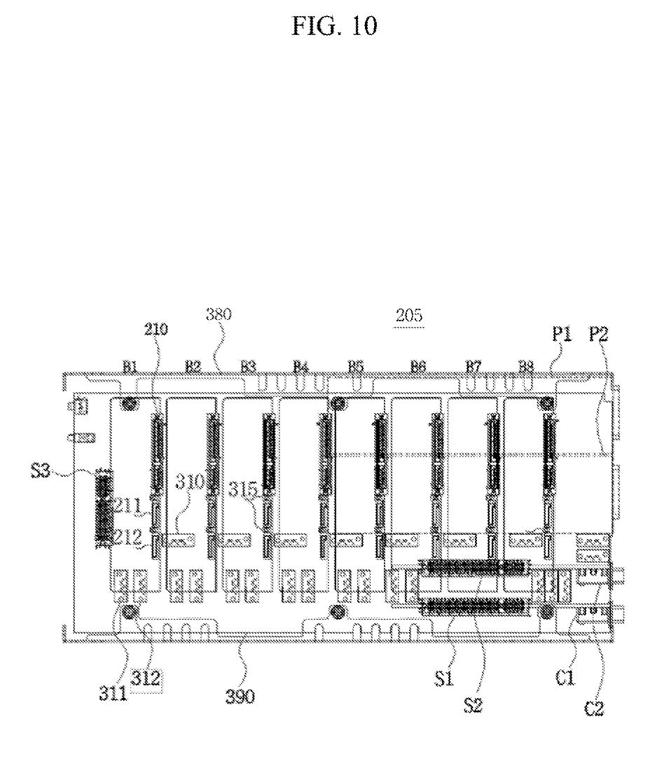

FIG. 10 is a view of a configuration of a backplane board 205 for the multi-device bay system 200 having power supply units P1 and P2 and fastening brackets 380 and 390, wherein the SSD doubler is coupled to the backplane board 205. An embodiment in which one SSD doubler 100A is connected to the backplane board will be described below.

When the SSD doubler 100A according to the second embodiment of the present invention is inserted through the vertically provided external hard guide 154a, the first connector portion 110, the second connector portion 111, and the third connector portion 112 of the SSD doubler 100A are connected to first connection units 210, 211, and 212 of the backplane board 205.

Second connection units 310, 311, and 312 disposed on a rear surface of the backplane board 205 are sequentially connected to the first connection units 210, 211, and 212 through impedance wires of interface signals configured as a differential pair.

PCI Express slots S1, S2, and S3 are provided at lower left and lower right portions of the rear surface of the backplane board 205, and wires connected in a pin-to-pin manner are provided between the two slots S1 and S1 at the lower right portion.

Accordingly, any PCI Express interface card C2 inserted into the PCI Express slot S2 is connected to a RAID card C1 inserted into another PCI Express slot S1 through a PCI Express interface signal.

The RAID card C1 changes a PCI Express interface signal to a SATA (an SAS or a SATA Express) signal or changes a SATA (an SAS or a SATA Express) signal to a PCI Express interface signal. The RAID card C1 is equipped with a cache memory serving as a kind of buffer memory in order to efficiently process such an operation.

A SATA (or an SAS or a SATA Express) port (not shown) is included in the RAID card C1 and correspondingly connected to the second connection units 310, 311, and 312 provided on the rear surface of the backplane board 205 through a separate SFF-8087 cable such as a SATA cable or an SAS-to-SATA conversion cable.

Thus, the SSD doubler 100A having a multi-interface port according to the second embodiment of the present invention and inserted into the multi-device bay system 200 forms a signal connection path from the first connection units 210, 211, and 212 to the second connection units 310, 311, and 312, then to the RAID card C1, and finally to the PCI Express interface card C2.

As a unit for receiving light related to an operation monitoring signal of each of the storage media 134, 135, and 136 from an LED light emitting device included in the SSD doubler 100A according to the second embodiment of the present invention, a PHOTO-TR 315 is disposed on the backplane board 205 at a shortest distance from a position of an LED of the SSD doubler 100A. As the LED emits light depending on on/off states, the PHOTO TR 315 may output a low or high state signal for a corresponding logical level.

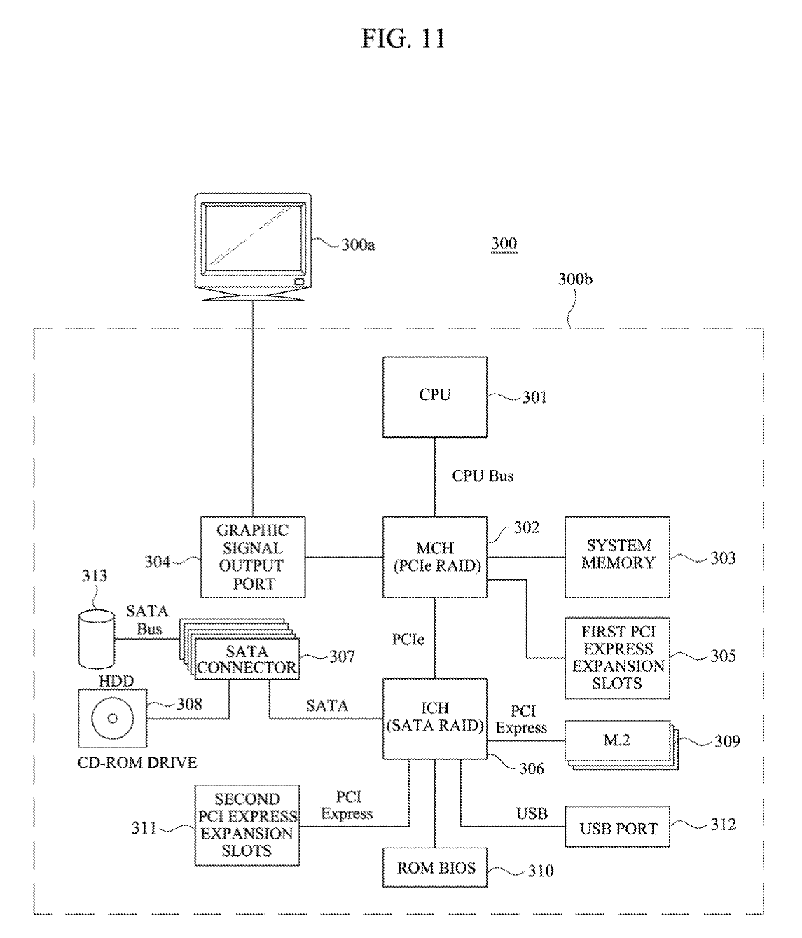

FIGS. 11 to 15 are associated with a third embodiment of the present invention. An SSD doubler is similar in form to a 3.5-inch hard disk drive (HDD) in terms of a placement of interface ports and locations of fastening holes, but has a limitation in expandability because a thickness or width of the 3.5-inch HDD cannot be exceeded when a bay and an external interface port for accommodating a storage medium inserted from the outside are expanded. As a solution for this problem, an SSD doubler 100B having the form of a PCI Express (or PCIe) add-in card is proposed, and the SSD doubler 100B is capable of detecting faults through a hardware method or a software method.

That is, various types of SSDs are commercially available depending on interface types and external shapes thereof. The interface types include, for example, SATA3 (6 Gbps), M.2 SATA, M.2 PCI Express, PCI Express, Mini PCI-E, USB (3.x, 2.0), Thunderbolt, SAS (6 Gbps), and the like, and the external shapes include, for example, a 1.8-inch card, a 2.5-inch card, a 3.5-inch card, an MGFF (M.2) card, a Mini SATA (mSATA) card, a PCI-E card, and the like.

However, the most commonly used SSD is a 2.5-inch SSD with a SATA3 (6 Gbps) interface and may be a PCI-E card type SSD when capacity as well as performance is considered.

In particular, a PCIe card type SSD may have a non-volatile memory device directly mounted on its own board. Also, a PCIe card type SSD having a memory module smaller than that of mSATA or M.2 is emerging.

However, such a PCI-E card type SSD includes a controller in a PCI-E card to enable the controller to perform interfacing through PCIe edge fingers, uses a fixed memory address method for memories mounted on the PCI-E card, and has functional limitations to RAID0 (Stripe) for internal capacity expansion.

Thus, the SSD doubler 100B according to the third embodiment of the present invention is provided as a PCI-E card SSD doubler allowing a 2.5-in SSD that offers relatively large capacity compared to a most widely used SSD with other external appearances or an equivalent storage medium to be mounted or easily removed or replaced. Also, the SSD doubler 100B may enable a user to arbitrarily set a necessary RAID function by means of RAID functions provided by an internal chipset of a motherboard connected to a SATA port or a PCI Express port provided on the motherboard or may be used in conjunction with a separate dedicated RAID having the form of a PCI-E card.

This will be described in detail with reference to FIGS. 11 to 15. In the following description, the same elements as those shown in FIGS. 2 to 10, which are associated with the first and second embodiments of the present invention, will be denoted with the same numerals, and redundant descriptions thereof will be omitted.

FIG. 11 is a block diagram of a personal computer system 300 which includes a monitor 300a and a motherboard 300b and in which the SSD doubler 100B according to the third embodiment of the present invention is installed. Detailed functional blocks thereof will be described below.

Conventionally, it was possible to configure a RAID function for multiple storage media by means of a separate System-on-Chip (SoC) RAID controller or a RAID card having the RAID controller. However, as semiconductor process technology has been developed to the extent that the wire width is in units of nanometers, the foundation for an embedded storage system having a small number of storage media is established without the use of an expensive external storage system due to the emergence of a central processing unit (CPU) 301 and its accompanying chipset to which new process technology is applied.

Thus, the CPU 301, which process various kinds of operations, is connected to a memory channel hub (MCH) 302, and the MCH 302 has a graphic signal processing block and also a first RAID function block depending on cases and is connected to a system memory 303.

A graphic signal output by the MCH 302 is connected to the monitor 300a, which is an external display unit, through a graphic signal output port 304.

The system memory 303 stores I/O address data and memory map address data of various kinds of plug and play devices that are recognized by the CPU 301 while a computer is booted. Various registers and various user application programs such as an operating system reside on the system memory 303, and a graphic user interface (GUI) and registers that are associated with the SSD doubler 100B according to the third embodiment of the present invention reside on the system memory 303.

First PCI Express expansion slots 305 are connected to the MCH 302 to process an external graphic card or large amounts of data, and also an I/O channel hub (ICH) 306 responsible for controlling various additional devices is connected to the MCH 302.

The first PCI Express expansion slots 305 and the ICH 306 are connected through the MCH 302 by means of a PCI Express bus.

The ICH 306 has a PCI-E to SATA conversion block and a second RAID function block embedded therein. A plurality of SATA connectors 307, a CD-ROM drive 308, or the like are connected to SATA pins included in an IC package of the ICH 306 by means of a SATA bus, and a port for a M.2 memory module 309 based on a PCI Express interface is connected to the SATA pins by means of a PCI Express bus.

A ROM bios 310 for controlling computer booting or various status settings and a second PCI-E expansion slots 311 are connected to the ICH 306. Recently, a PCI-E to USB conversion block is structurally embedded in the ICH 306 and is connected to a USB port 312.

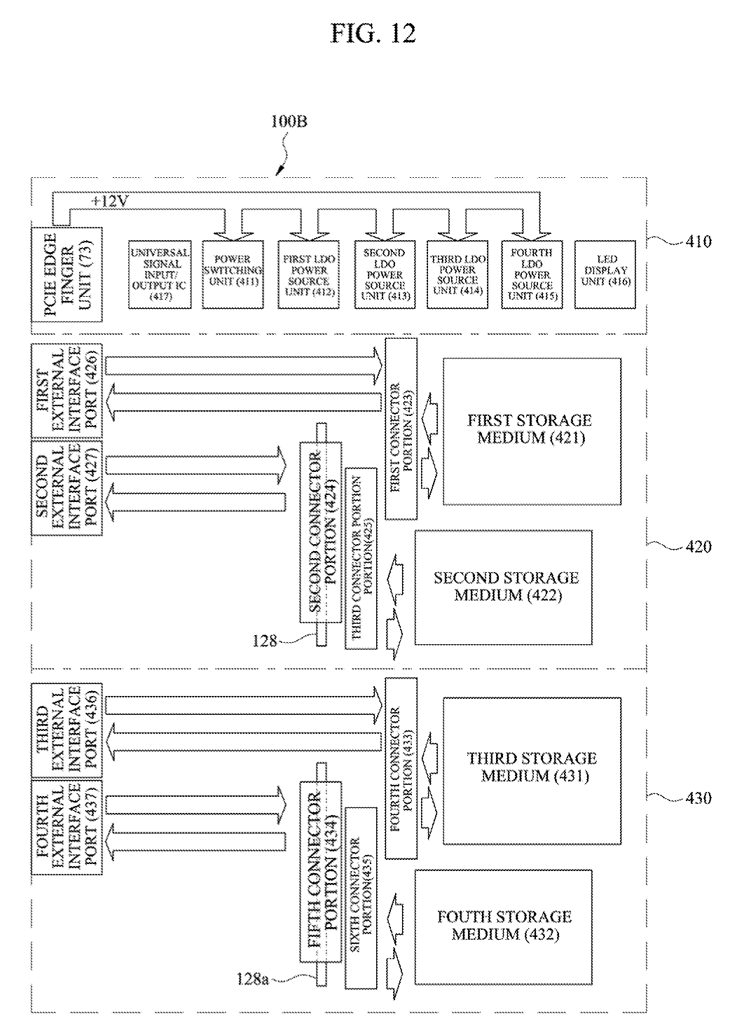

FIG. 12 shows a block diagram of the SSD doubler 100B according to the third embodiment of the present invention. The SSD doubler 100B has the form of a PCI-E add-in card having the PCIe edge fingers 73 shown in FIG. 4, and detailed functional blocks and elements thereof will be described below.

First, a power and element function unit 410 is composed of a power switching unit 411 configured to generate various levels of power used by the SSD doubler 100B according to the third embodiment of the present invention, a plurality of low-dropout (LDO) power source units 412, 413, 414, and 415, an LED display unit 416, and a universal signal input/output integrated circuit (IC) 417.

The power switching unit 411 receives +12V power from a power pin of the PCIe edge finger 72 and generates +5V power to be supplied to a storage medium inserted from the outside and power to be needed by the universal signal input/output IC 417, which is connected to data input/output pins of the PCIe edge finger 73.

The first to fourth LDO power source units 412, 413, 414, and 415 are power supply devices corresponding to individual storage media inserted from the outside. When the power switching unit 411 uses the first to fourth LDO power source units 412, 413, 414, and 415 to generate only a voltage for the universal signal input/output IC 417 or when the number of SSD bay body units provided on the PCI-E card increases by means of a stacked structure, output power capacity of the single power switching unit 411 should increase. Instead, it may be a good idea to provide an LDO power source unit corresponding to an individual storage medium.

However, the LOD power source unit may have a heating problem in generating +5V power from +12V power, and thus may be replaced with a small power switching unit.

Alternatively, when a failure occurs in the power switching unit 411 while main power is supplied to an individual storage medium as an output of the power switching unit 411, a separate power switching unit (not shown) may be provided and used to improve power stability for the purpose of applying LDO power to an individual storage medium.

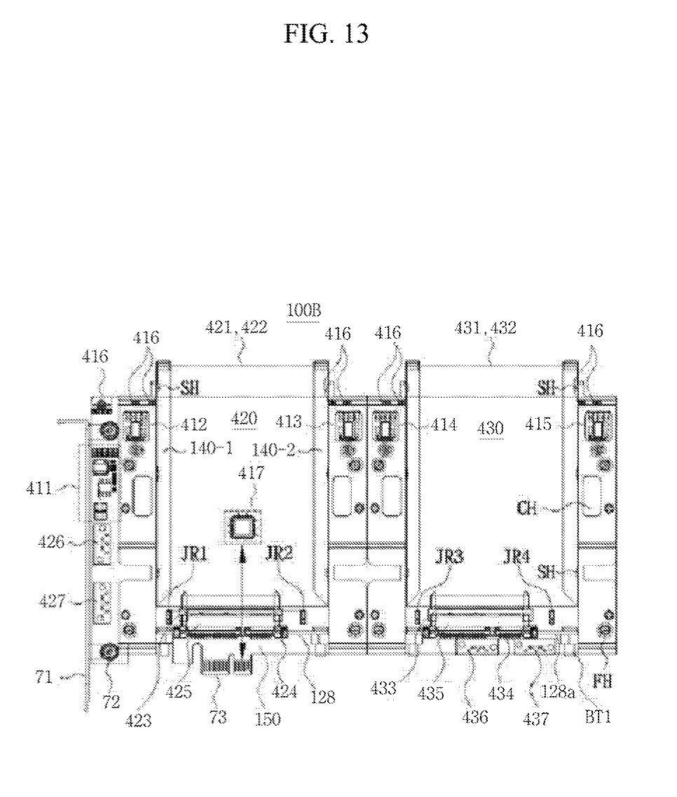

The LED display unit 416 receives an operation status signal (ACTIVITY) generated when an external storage media operates and displays the signal with an LED, and the LED display unit 416 receives a fault occurrence signal (FAULT) output from the universal signal input/output IC 417 and displays the signal with an LED. An LED display unit operation will be described below with reference to FIG. 13.

The universal signal input/output IC 417 is directly connected to a data input/output pin of the PCIe edge finger 73 and configured to receive a status signal from the CPU 301 through the MCH 302 and the first PCI Express expansion slots 305 or through the MCH 302, the ICH 306, and the second PCI Express expansion slots 311, and operate a fault indication (FAULT) LED for displaying a fault that has occurred in a storage medium among the inserted storage media.

A first unit SSD doubler 420 shown in FIG. 12 includes a first connector portion 423 to which a first storage medium inserted from the outside is first connected and a first external interface port 426 directly connected to the first connector portion 423 by wires, which constitute a lower portion of the bay bodies 140-1 and 140-2 and further includes a second connector portion 424, which is a horizontal (right angle) type connector, having an entrance corresponding to a storage medium inserted from the outside. In this case, a second storage medium 422 is directly connected to the entrance of the second connector portion 424, and the second connector portion 424 is connected to a second external interface port 427 through direct wiring.

When the second connector portion 424 is not a horizontal (right angle) type connector in which the shape of the storage medium entrance of the second connector portion 424 is positioned at an upper portion of the bay bodies 140-1 and 140-2, and also the storage medium entrance of the second connector portion 424 is not directly connected to an interface connector (not shown) included in the second storage medium 422 inserted through an upper bay of the bay bodies 140-1 and 140-2, it is possible to replace the second connector portion 424 having the horizontal type by using a vertical type SATA connector that is widely used as the second connector portion 424 and using the same vertical type SATA connector at one side surface of the vertical connection board 128 as a third connector portion 425 to connect a storage medium inserted through the upper bay of the bay bodies 140-1 and 1402 to the second connector portion 424.

A second unit SSD doubler 430 shown in FIG. 12, which is a duplication of the first unit SSD doubler 420, includes a fourth connector portion 433 corresponding to the first connector portion 423, a fifth connector portion 434 corresponding to the second connector portion 424, a vertical connection board 128 corresponding to the vertical connection board 128a, and a sixth connector portion 435 corresponding to the third connector portion 425. An external interface port is configured such that a third external interface port 436 corresponds to the first external interface port 426 and a fourth external interface port 437 corresponds to the second external interface port 427.

The second unit SSD doubler 430 may be physically disposed over the first unit SSD doubler 420 to form a vertically stacked structure and may be disposed next to the first unit SSD doubler 420 side by side to form a horizontal structure.

When the first and second unit SSD doublers 420 and 430 are disposed vertically to each other, the entire thickness of the SSD doubler 100B increases, but the length of the printed circuit board advantageously decreases. When the first and second unit SSD doublers 420 and 430 are disposed horizontally to each other, the entire thickness of the SSD doubler 100B decreases such that an adjacent SSD doubler 100B is prevented from intruding on a PCI-E slot adjacent to the first PCI Express slots 305 or the second PCI Express slots 311, but the length of the SSD doubler 100b disadvantageously increases.

FIG. 13 shows a structure of the SSD doubler 100B according to the third embodiment of the present invention wherein the first and second unit SSD doublers 420 and 430 are horizontally disposed in parallel with each other.

As shown in FIG. 13, the SSD doubler 100B according to the third embodiment of the present invention has the form of a PCI-E card. Thus, at a left side, a PCIe bracket 71 used to fasten the card to a main body 300 of a computer is fastened to a bracket fastening hole 72 provided on the printed circuit board 150 by means of a separate fastening unit (not shown) such as a bolt.

The PCIe edge finger 73 is disposed at a lower portion in the form of a PCIe ×1. Among power pins at a left area, +12V power is connected to input power sources of the first to fourth LDO power source units 412, 413, 414, and 415 included inside a multipurpose hole GH provided on the power switching unit 411 and the bay bodies 140-1 and 140-2 at an upper left portion, and +3V power is used to operate general logic-level components, including LEDS.

The power switching unit 411 generates +5V power as an operation voltage for driving external storage media as described above with reference to FIG. 12 and also generates power with a voltage other than +3.3V used for the universal signal input/output IC 417.

An LDO power source included inside multipurpose holes GH formed in the bay bodies 140-1 and 140-2 outputs +5V power, and one LDO power source unit operates only one storage medium.

Whether to operate each of the storage media 421, 422, 431, and 432 by using individual power output by small LDO power source units 411, 412, 413, 414, and 415 or by using single power output by the power switching unit 411 is determined in consideration of material cost and heat generation of an LDO during a detained product design process. However, 3-pin jumper resistors JR1, JR2, JR3, and JR4 may be included in the printed circuit board 150 and used to select power to be input to a storage medium.

The universal signal input/output IC 417 is connected to data input/output pins disposed at a right area of the PCIe edge finger 73 through PCIe ×1, and disposed on a lower surface of the printed circuit board 150 so that the universal signal input/output IC 417 does not work as an obstacle to a storage medium inserted into a lower bay at a lower portion of the bay bodies 140-1 and 140-2.

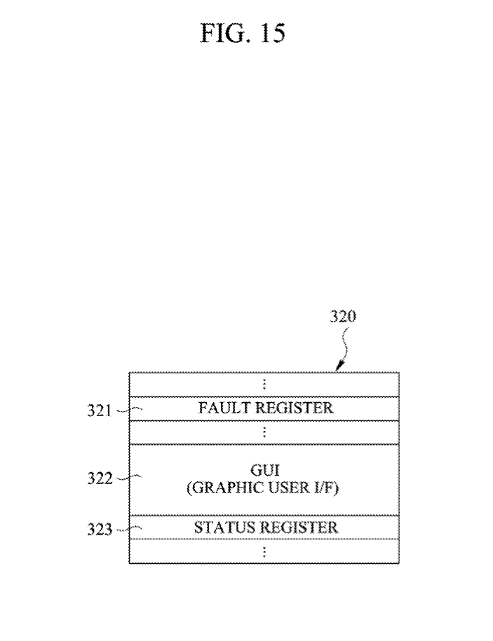

The operation of the universal signal input/output IC 417 has been briefly described with reference to FIG. 12, but will be described in detail with reference to FIG. 15.

The first unit SSD doubler 420 is disposed a predetermined distance over the PCIe edge finger 73 to accommodate a storage medium inserted from the outside of the left and right bay bodies 140-1 and 140-2 and is firmly fastened to fastening holes FH included in the left and right bay bodies 140-1 and 140-2 at the lower portion of the printed circuit board 150 by means of a fastening unit (not shown) such as a bolt.

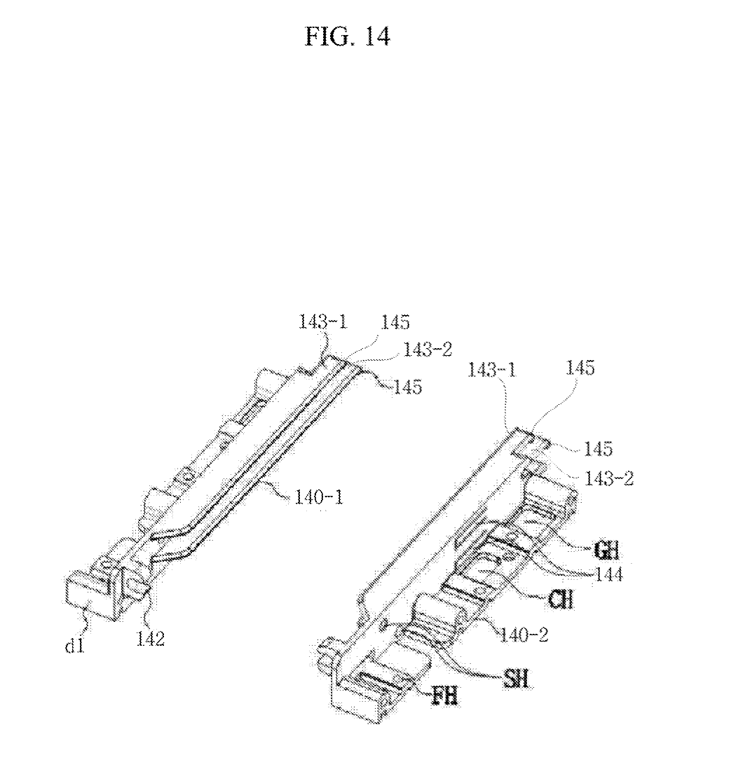

As shown in FIG. 14, a lower bay is formed at an entrance of an end surface d1 252 of the bay bodies 140-1 and 140-2, the first connector portion 423 is disposed at an end point to which the first storage medium 421 is guided, and the second connector portion 424 is disposed under the first connector portion 423 vertically to the printed circuit board 150.

The vertical connection board 128 is inserted into an entrance provided at the second connector portion 424, and the third connector portion 425 having the same shape as the second connector portion 424 is disposed, on the vertical connection board 128, at a position corresponding to an interface connector (not shown) of a second storage medium guided and inserted through an upper bay formed by the left and right bay bodies 140-1 and 140-2.

In this case, the vertical connection board 128 is supported by a vertical connection board fastening protrusion 142 and fastened by means of a fastening bolt BT1 and a nut (not shown) in a direction from the storage media to the end surface dl of the bay bodies 140-1 and 140-2.

Data input/output pins of the first connector portion 423 that are directly connected to the first storage media 421 are correspondingly connected to the first external interface port 426 by wires, and data input/output pins of the second connector portion 424 are correspondingly connected to the second external interface port 427 by wires.

Since there is not enough room to place the first external interface port 426 and the second external interface port 427 in a space between the PCIe edge finger 73 and the second connector portion 424 due to various kinds of wires connected with a power pin and data pins constituting the PCIe edge finger 73, it is preferable that the first and second external interface ports 426 and 427 be disposed in a space between the PCIe bracket 71 and the right bay body 140-1 as shown in FIG. 13.

However, the bay bodies 140-1 and 140-2 of the present invention include connector holes CH in which the first to fourth external interface ports 426, 427, 436, and 437 may be disposed, and thus there is no problem in placing the external interface ports 426, 427, 436, and 437 by means of the connector holes CH. However, it is preferable that the external interface ports 426, 427, 436, and 437 be disposed at the locations shown in FIG. 13 in order to keep the wiring length as short as possible.

In particular, one of the first and second external interface ports 426 and 427 may be replaced with the same power-pin-integrated connector as having been used for the second connector portion 424. In this case, a SATA power cable (not shown) included in an ATX power module (not shown) inside the computer may be directly connected to a power pin area of the replaced first external interface port 426.

Since +12V power, +5V power, and +3.3V power are input through a SATA power cable (not shown), there is no need to include the power switching unit 411 or the first to fourth LDO power source units 412, 413, 414, and 415 in order to generate +5V power. Like the case of the PCI-E add-in card type graphic card to which an additional power cable is connected from an ATX power module, it may be cumbersome due to the connected power cable.

It has been described that one of the first and second external interface ports 426 and 427 may be replaced with the same power-pin-integrated connector as the second connector portion 424. However, while the first and second external interface ports 426 and 427 are maintained, a dedicated power connector for receiving external power through a separate cable may be provided.

The bay bodies 140-1 and 140-2 includes concave-convex grooves at a lower portion brought into surface contact with the printed circuit board 150. An operation indication (ACTIVITY) LED and a plurality of fault indication (FAULT) LEDs 416 of the LED display unit 416 may be disposed on a corresponding printed circuit board 150 to correspond to storage media.

In this case, the bay bodies 140-1 and 140-2 are made of a transparent material such as polycarbonate, and an LED light emitted from a lower portion of a support fixture is spread over all the unit bay bodies 140-1 and 140-2 by using the bay bodies 140-1 and 140-2 as a light guide plate.

In particular, the PCI-E add-in card type SSD doubler 100B according to third embodiment of the present invention is mounted on a general computer 300, the bay bodies 140-1 and 140-2 disposed on an upper surface of the printed circuit board 150 may be oriented downward, and thus visibility may not be good.

Due to this problem, it is preferable that the bay bodies 140-1 and 140-2 have a length slightly greater than the length of the printed circuit board 150, and it is also preferable that the storage medium entrance outwardly protrude from the printed circuit board 150 when the bay bodies 140-1 and 140-2 are disposed on the printed circuit board 150.

For the LED display unit 416, the operation indication LED emits light in cooperation with an operation indication signal output from each storage media, and the fault indication LED be operated by a signal output by the universal signal input/output IC 417.

Also, at an upper left corner, all operation indication LEDs and all fault indication LEDs are disposed at a lower portion of an LED light guide structure that is surface-processed to scatter light and that protrudes to improve visibility.

All the operation indication LEDs are operated through an IC (not shown) for receiving a signal output from each storage medium and performing a logical conjunction on the received signal, and all the fault indication LEDs are operated by performing a logical conjunction on signals output by the universal signal input/output IC 417 in the same way or are operated by all fault indication LED signals output by the universal signal input/output IC 417.

The second unit SSD doubler 430 shown at the right side of FIG. 13 is disposed alongside the first unit SSD doubler 420 as shown in FIG. 12. The third and fourth external interface ports 436 and 437 are disposed under the fifth connector portion 434 in order to shorten wires therebetween.

For the vertically stacked structure in which the second unit SSD doubler 430 is placed on the first unit SSD doubler 420, a thin printed circuit board (not shown) having the same width and length as those of a lower surface of the second unit SSD doubler 430 is added to the lower surface. Although not shown, a lower printed circuit board 150 and an upper printed circuit board (not shown) have electrical circuit connections for operating the LEDs of the LED display unit 416 disposed at a side surface and an upper surface of the second unit SSD doubler 430 by means of the left and right connectors included in the multipurpose holes GH or the connector holes CH.

At the entrance of the end surface dl of the bay bodies 140-1 and 140-2, the fourth connector portion 433 and the sixth connector portion 435 corresponding to an interface connector of a storage medium inserted through a bay formed in the second unit SSD doubler 430 is disposed over the third connector portion 433. To this end, the vertical connection board 128a expands upwardly.

The vertical connection board 128 is supported and fastened by the upper and lower vertical connection board fastening protrusions 142 in the same way as the method of fastening the first unit SSD doubler 420.

In this case, when the second connector portion 424 uses a general SATA connector, a data input/output signal mapped to the second SSD doubler 430 is configured so that +3.3V power pins and adjacent ground pins are connected to data input/output pins of the fourth connector portion 433 and +12V power pins and adjacent ground pins of the second connector portion 424 are connected to data input/output pins of the sixth connector portion 435. In this case, the fifth connector portion 434 is no longer utilized.

Irrespectively of the unit SSD doublers 420 and 430 being disposed in a horizontal or vertical direction, the positions of the first to fourth external interface ports 426, 427, 436, and 437 are not changed.

As the type of the external interface is changed to SATA, SATA Express, or PCI Express, the shape of the connector for the first to fourth external interface ports 426, 427, 436, and 437 may be changed, and it is possible to use the SSD doubler 100B according to the third embodiment of the present invention to correspond to the SATA or PCI Express interface.

In addition, the first to sixth connector portions 423, 424, 425, 433, 434, and 435 may be implemented using a SATA connector, SAS connector, or SATA Express connector or an SSF-8639 connector (not shown) for accommodating all the three connectors or may be replaced with a general high-performance/high-density connector suitable for a high-speed data signal interface, not an SFF connector.

When the unit SSD doublers 420 and 430 are horizontally disposed alongside each other, an inserted storage media may be firmly fastened by using SSD side fastening holes of the bay bodies 140-1 and 140-2 that are outwardly exposed and not adjacent to the unit bay bodies 140-1 and 140-2, or by using left and right SSD side fastening holes SH while the doublers are disposed in a vertically stacked structure.

When the unit SSD doublers 420 and 430 are horizontally disposed alongside each other, it is preferable that the two adjacent SSD doublers 420 and 430 are firmly connected to each other by means of a cross bar (not shown) that includes a vertical connection board fastening hole for the purpose of mechanical strength reinforcement by positioning the cross bar (not shown) in surface contact with the end surface dl of the bay bodies 140-1 and 140-2 in addition to the printed circuit board 150 and fastening the SSD doublers to fastening holes included in the cross bar (not shown) through the fastening holes of the vertical connection board fastening protrusions 142 of the bay bodies 140-1 and 140-2 by means of a fastening bolt BT1.

It has been described that the unit SSD doubler 420 is disposed alongside the PCIe edge finger 73. However, depending on implementations, the unit SSD doublers 420 are horizontally disposed so that the end surface dl of the bay bodies 140-1 and 140-2 is oriented toward or away from the PCIe bracket 71. Correspondingly, the second SSD doubler 430 may be vertically stacked thereon.

In this case, by placing a through-hole at a place matching a line extending from a central line of an SSD side fastening hole SH adjacent to the PCIe bracket 71, it is possible to easily use a tool such as a screw driver (not shown).

FIG. 14 is a perspective view of the left and right bay body according to the third embodiment of the present invention, wherein a default structure for guiding an external storage media and forming a bay is the same as those in the first and second embodiments of the present invention.

However, the PCI-E add-in card type SSD doubler 100B according to the third embodiment of the present invention has a different shape in which the end surface dl of the bay bodies 140-1 and 140-2 is cut to fit the length of the printed circuit board 150, and additionally includes a connector hole CH in order to place a connector for electrical circuit connection in preparation for expansively including a third or fourth unit SSD doubler (not shown) according to a placement purpose or a 2-stage stack of the external interface ports 426, 427, 436, and 437.

The bay bodies 140-1 and 104-2 will be described in detail below. A storage medium inserted through a bay formed by the left and right bay bodies 140-1 and 140-2 is accurately guided in a forward and backward direction by the elastic guide bars 143-1 and 143-2 protruding in a horizontal direction. When an interface connector (not shown) included in the storage media is correspondingly coupled to the fourth connector portion 433 or the sixth connector portion 435 in addition to the first and third connector portions 423 and 425, an opposite end portion of the storage medium serves to stably maintain the inserted storage medium by means of an elastic force of the storage medium supporting protrusions 145 provided at ends of the elastic guide bars 143-1 and 143-2 unless an artificial force is applied to move the inserted storage medium to the outside.

In addition, the side holder is provided inside each bay formed by the left and right bay bodies 140-1 and 140-2, thereby preventing the inserted storage medium from being shaken by lateral vibration.

FIG. 15 shows a register 320 of a system memory 303 according to the third embodiment of the present invention. A detailed description will be provided on the assumption that the PCI-E add-in card type SSD doubler 100B is inserted into second PCI Express expansion slots 311 inside the computer system 300.

When a power switch (not shown) of the computer system 300, the CPU 301 performs a plug-and-play operation for various peripheral devices according to a program embedded in the ROM bios 310, designates an I/O address range and a memory address range required for an interface by the peripheral devices, and allocates the ranges to a corresponding region of the system memory 303 to configure the main memory 320.

Accordingly, an I/O address range and a memory address range required by the universal signal input/output IC 417 installed in the PCI-E add-in card type SSD doubler 100B according to the third embodiment of the present invention are allocated to the universal signal input/output IC 417 for the purpose of a subsequent interface. The SSD doubler 100B reads a device ID and a vender ID, detects the use of the device and the manufacturer of the device, and registers and stores the use and the manufacturer in the main memory 320 included in the system memory 303.

The device detection operation for external SATA storage media connected to the SATA connector 307 proceeds through a SATA interface block embedded in the ICH 306 during the plug-and-play operation process.

When the default plug-and-play operation ends and a task of extracting default information and correspondingly allocating resources (an I/O address range, a memory address range, and an interrupt channel, etc.) ends, the ROM bios 310 uploads an operating system from a storage medium 313 in which the operating system is installed to the system memory 303. When the upload of the operating system on the system memory 303 ends, the operating system reads the main memory 320 during the plug-and-play operation performed by the ROM bios 310 and recognizes the register device in the level of the operating system.

Subsequently, during the process of uploading the operating system to the system memory 303, the CPU 301 searches a registry registered in the main memory 320, executes start programs that should reside on the main memory according to the search result, makes the programs reside on the system memory 303, and places icons (coordinates, shapes, etc.) of associated programs on a wallpaper. Such an operation is also actually intended to perform recording in and exposure to a designated area of the system memory 303.

When a user executes a RAID function setting program in order to use the PCI-E add-in card type SSD doubler 100B according to the third embodiment of the present invention, an RAID program installed in the external storage medium 313 resides in an arbitrary region of the system memory 303 and is displayed on an external monitor 300a connected to the graphic signal output port 304 through a graphic signal processing block (not shown) of the memory channel hub 302 in the form of a graphic user interface (GUI). In this case, information regarding external storage media recognized during a plug-and-play process of a booting process may is recognized through a status information register 276.

When the user selects the recognized storage media through the graphic user interface and sets RAID functions for the storage media, the information is delivered to a RAID function block (not shown) included in the ICH 306, and the RAID function block performs the RAID setting in hardware level.

Before this, the user individually performs designation on a virtual image of the PCI-E add-in card type SSD doubler 100B according to the third embodiment of the present invention, which is drawn on the graphic user interface, by matching the first to fourth external interface ports 426, 427, 436, and 437 included in the SSD doubler 100B to SATA connectors 307 included in the computer system 300.

Subsequently, when the user designates the virtual image of the SSD doubler 100B by selecting an arrow direction included in the graphic user interface and predetermined various location shapes so that when a failure occurs in any storage medium, the user can intuitively determine in which of storage media included in the SSD doubler 100B a fault has occurred, various status information is stored in the main memory 320. When the graphic user interface ends, the register information including the various status information is recorded at a designated position of the external storage medium 313, which is a non-volatile storage medium.

As reference, the graphic user interface has a square computer system appearance, which is an enhanced form. This allows a shape similar to that of the user's computer system to be obtained by extending or shortening a corner of the computer system appearance in an arbitrary direction by means of, for example, a mouse and also allows selection of main components to be disposed and a surface in which the main components, such as the motherboard 300b and a power module, will be disposed.

Subsequently, the user selects a storage medium based on forms from a storage media library included in a toolbar menu of the graphic user interface and places the storage medium at a corresponding position by performing a dragging and dropping operation and then designating an installation direction.

Accordingly, as a storage medium unit of which operation status is intended to be monitored, the types of storage media connected to the SSD doubler 100B shown in FIG. 13, the SSD doubler 100 according to the first embodiment of the present invention, and the SATA connector 307, the first PCI Express expansion slots 305, the second PCI Express expansion slots 311, and M.2 slot (309) of FIG. 11 may be arbitrarily selected.

When a heterogeneous-connector-based storage media such as a 3.5-inch hard disk drive is dragged and dropped to the PCI Express expansion slot 311 on the motherboard 300b instead of the PIC Express add-in card type SSD or the SSD doubler 100 shown in FIG. 4, a fault message is generated by means of, for example, a beep sound and a pop-up window.

It has been described that actual placement can be implemented by selecting storage media to be monitored from the storage medium library and then performing a dragging and dropping operation. However, it is also possible to place the storage media by specifying the quantity of storage media for each type thereof by a menu and then performing horizontal or vertical movement on a position selection menu and its associated detailed replacement menu.

Under the above-described graphic user interface environment, when the computer system 300 is turned on while pre-displacement for each storage medium is completed, the pre-installed storage media are activated at corresponding positions and their presence is confirmed. Subsequent storage media will appear to be new when the status information register 276 is updated.

On the other hand, if a failure occurs in an arbitrary storage medium of the SSD doubler 100B while the user is normally using the computer system 300, the CPU 301 pops up a resident program stored in the system memory 303 to the monitor 300a in association with the PCI-E add-IN card type SSD doubler 100B according to the third embodiment of the present invention POP-UP) to display a graphical user interface, and displays the storage medium having the failure among the storage medium of the SSD doubler 100B exposed as a virtual graphic image such that the storage medium having the failure can be distinguished in red to enable the user to intuitively recognize the storage medium having the failure.

In addition, the program residing on the system memory of the SSD doubler 100B records the failure occurrence information for any storage medium read from the ICH 306 under the control of the CPU 301 in a fault register 321 of the main memory 320 of FIG. 15 and transfers this information to the universal signal input/output IC 417 provided in the SSD doubler 100B.

The above method can be performed only when address information of the status information register for a RAID block embedded in the ICH 306.

Therefore, as another method of checking whether storage media have a fault, a method of checking status information (Self-Monitoring Analysis and Reporting Technology; SMART) of each storage medium at predetermined intervals when a KERNEL mode program residing in the system memory 303 and linked with the graphical user interface determines that no data access to the storage medium occurs and updating the fault register 321 of the main memory 320 with the fault information when it is determined that a failure has occurred in an arbitrary storage medium may be used.

When the universal signal input/output IC 417 of the SSD doubler 100B according to the third embodiment of the present invention outputs the storage medium fault information input by the PCI Express interface to an output port, a fault indication LED linked with the output port is turned on, and the storage medium at the position where the fault occurred is primarily confirmed through the graphic user interface. Also, the universal signal input/output IC 417 guides the user to recognize the storage medium at the accurate position by means of red light emission indication exposed to the outside of an SSD support fixture entrance by using the bay bodies 140-1 and 140-2 as a light guide plate by the fault indication LED included at a lower portion of the bay bodies 140-1 and 140-2 in the replacement step.

When this process is not performed, the user may misrecognize the position of the storage medium having the failure. When the user thinks that he or she correctly knows the position and replaces a normal storage medium that is not located at the exact position even though he or she misrecognizes the position, data may be lost even in a RAID 5 configuration. Even in the last step of storage under dual recovery bits of RAID6, when the user thinks that the recognized position is correct, the data may also be lost. Accordingly, it is preferable that the faulty position be exposed in two steps as described above.

In the case in which a failed storage medium is replaced with a normal storage medium by the above-described fault tracking method for the failed storage medium, when the SATA conversion block built in the ICH 306 determines that the storage medium is normal and updates an internal resister (not shown) by replacing a fault bit for the faulty storage medium with a normal bit, the CPU 301 reads this information, updates the fault register 321 indicated in the main memory 320 and 270, notifies the user that the faulty storage medium displayed on the system-memory-resident program associated with the SSD doubler 100B is converted into and correctly replaced with a normal storage medium, and updates the status information register 323 of the main memory 320.

For convenience of description, the SATA interface has been described above as an example. However, when the storage media is a non-volatile memory (NVM) Express (NVMe) medium that supports an PCI Express interface, the above-described method can be applied to the PCI Express interface by changing the first to fourth external interface ports 426, 427, 436, and 437 into a PCI Express interface connector and performing cable mapping to a corresponding M.2 309 of the motherboard 300b.

Although the preferred embodiments of the present invention have been described in detail, those skilled in the art will appreciate that various modifications, additions and substitutions are possible, without departing from the scope of the appended claims.

1.-54. (canceled)

55. A solid-state drive (SSD) doubler comprising:
a printed circuit board;
a first connector portion provided horizontally to the printed circuit board and connected to an outside;
a controller connected to the first connector portion;
a sixth connector portion configured to connect the controller to a first storage medium;
a fourth connector portion configured to connect the controller to a second storage medium; and
a bay body configured to vertically form a plurality of bays so that the first storage medium and the second storage medium are guided toward the sixth connector portion and the fourth connector portion in a stacked structure.

56. The SSD doubler of claim 55, wherein the sixth connector portion is provided horizontally to the printed circuit board, and the fourth connector portion is provided, as a single connector portion or a plurality of connector portions, vertically to the printed circuit board.

57. The SSD doubler of claim 55, further comprising a vertical connection board connected to the fourth connector portion and at least one fifth connector portion vertically connected at one side of the vertical connection board, wherein a second storage medium or a third storage medium is correspondingly connected to the fifth connector portion.

58. The SSD doubler of claim 55, wherein the bay body is formed in one body.

59. The SSD doubler of claim 55, wherein the bay body is divided into a left body and a right body.

60. The SSD doubler of claim 55, wherein the controller configures connection by means of a SATA (or SATA Express or SAS) and/or PCI Express interface signal(s).

61. The SSD doubler of claim 57, wherein the vertical connection board is fastened to a vertical connection board fastening protrusion of the bay body by means of a fastening unit.

62. The SSD doubler of claim 61, wherein when the vertical connection board is fastened to one side of the vertical connection board fastening protrusion by means of a fastening bolt, the vertical connection board is fastened through a fastening hole provided in a front cover positioned at an opposite side of the vertical connection board fastening protrusion.

63. The SSD doubler of claim 55, wherein the bay body has a plurality of guide bars configured to guide an inserted storage medium and form stacked bays.

64. The SSD doubler of claim 63, wherein an elastic guide bar configured to press the inserted storage medium downward by means of elasticity is provided at an end of an entrance of each of the guide bars, and a storage medium supporting protrusion is provided at an end portion of the elastic guide bar.

65. The SSD doubler of claim 55, wherein the bay body has side holders positioned at both sides of each of the bays and inwardly protruding from the bay body to push a storage medium by means of elasticity thereof so that a storage medium inserted into each of the bays is stably guided and prevented from deviating outwards.

66. The SSD doubler of claim 55, wherein the bay body has an opening hole on an arbitrary horizontal surface of a bay configuration area that is in surface contact with the printed circuit board, and the bay body has a series of connection units for remotely controlling operations on an exposed printed circuit board within the opening hole.

67. The SSD doubler of claim 55, wherein the bay body has a fastening hole on a side surface thereof at a position corresponding that of a fastening hole provided at a side surface of a storage medium when the storage medium is maximally inserted.

68. The SSD doubler of claim 55, wherein the bay body has an operation mode setting unit on an arbitrary horizontal surface of a bay configuration area that is in surface contact with the printed circuit board.

69. The SSD doubler of claim 68, further comprising an operation recognition switch disposed at an upper portion of an end surface of the printed circuit board in which a storage medium entrance of the bay body for convenience of operation.

70. The SSD doubler of claim 69, wherein when the first storage medium and the second storage medium are installed, the controller enables the operation mode setting unit to select one of RAID0, RAID1, SPAN, and an operation mode for individual storage media, and when the operation recognition switch is pressed, the controller enables the operation mode setting unit to deliver the setting status to the controller.

71. The SSD doubler of claim 55, wherein the bay body has a “∩”-shaped groove disposed at a bottom surface so that an LED is disposed thereon.

72. The SSD doubler of claim 55, further comprising an LED light guide unit for an upper bay and an LED light guide unit for a lower lay disposed at both corners of the printed circuit board at a side of the storage medium entrance of the bay body.

73. The SSD doubler of claim 70, wherein the LED light guide unit has a “¬”-shaped opening groove on a bottom surface, and an LED is disposed on a printed circuit board below the opening groove to monitor an operation status.

74. The SSD doubler of claim 55, wherein the bay body has a storage medium fastening hole disposed at the storage medium entrance in the form of a “U”-shaped opening hole so that a storage medium is easily removed by mounting a separate storage medium removal unit on fastening holes at both sides of the storage medium through the “U”-shaped opening hole and then pulling the storage medium removal unit.

75. The SSD doubler of claim 55, wherein a plurality of bay bodies are disposed on the printed circuit board in a stacked structure to form multiple stages of bays.

76. The SSD doubler of claim 55, wherein when there are a plurality of bay bodies, the controller is configured to additionally support an operation mode such as RAID3, RAID5, RAID6, RAID10, RAID50, or RAID60 as the number of storage media increases.

77. The SSD doubler of claim 75, wherein the SSD doubler additionally has a fastening bracket including a through hole on an extension line corresponding to a side fastening hole of an adjacent bay body.

78. An SSD doubler having a multi-interface port, the SSD doubler comprising:
a printed circuit board;
a first connector portion provided horizontally to the printed circuit board and connected to an outside;
at least one second connector portion provided horizontally to the printed circuit board, disposed alongside the first connector portion, and connected to the outside;
a sixth connector portion configured to connect the first connector portion to a first storage medium;
a fourth connector portion configured to connect the second connector portion to a second storage medium or a third storage medium; and
a bay body configured to vertically form a plurality of bays so that the first storage medium and the second storage medium or the first storage medium, the second storage medium, and the third storage medium are guided toward the sixth connector portion and the fourth connector portion in a stacked structure.

79. The SSD doubler of claim 78, wherein the sixth connector portion is provided horizontally to the printed circuit board, and the fourth connector portion is provided, as a single connector portion or a plurality of connector portions, vertically to the printed circuit board.

80. The SSD doubler of claim 78, further comprising a vertical connection board connected to the fourth connector portion and at least one fifth connector portion vertically connected at one side of the vertical connection board, wherein a second storage medium or a third storage medium is correspondingly connected to the fifth connector portion.

81. The SSD doubler of claim 78, wherein the bay body is formed in one body.

82. The SSD doubler of claim 78, wherein the bay body is divided into a left body and a right body.

83. The SSD doubler of claim 78, wherein the fourth connector portion and the sixth connector portion, which correspond to the first connector and the second connector, respectively, configure connection by means of a SATA (or SATA Express or SAS) or PCI Express interface signal.

84. The SSD doubler of claim 78, wherein when the fourth connector portion is a SATA connector, +3.3V power pins and adjacent ground pins of the SATA connector are mapped to pins corresponding to an additional interface signal of the second connector portion.

85. The SSD doubler of claim 78, further comprising a front cover having a structure surrounding at least one outer surface of the first connector portion and the second connector portion.

86. The SSD doubler of claim 85, wherein the front cover has a vent hole configured to facilitate air flow to an inner side with respect to the front cover by adhering to top surfaces of the first connector portion and the second connector portion without surrounding left and right side surfaces of the first connector portion and left and right side surfaces of the second connector portion.

87. The SSD doubler of claim 80, wherein the vertical connection board is fastened to a vertical connection board fastening protrusion of the bay body by means of a fastening unit.

88. The SSD doubler of claim 87, wherein when the vertical connection board is fastened to one side of the vertical connection board fastening protrusion by means of a fastening bolt, the vertical connection board is fastened through a fastening hole provided in a front cover positioned at an opposite side of the vertical connection board fastening protrusion.

89. The SSD doubler of claim 78, wherein the bay body has a plurality of guide bars configured to guide an inserted storage medium and form stacked bays.

90. The SSD doubler of claim 89, wherein an elastic guide bar configured to press the inserted storage medium downward by means of elasticity is provided at an end of an entrance of each of the guide bars, and a storage medium supporting protrusion is provided at an end portion of the elastic guide bar.

91. The SSD doubler of claim 78, wherein the bay body has side holders positioned at both sides of each of the bays and inwardly protruding from the bay body to push a storage medium by means of elasticity thereof so that a storage medium inserted into each of the bays is stably guided and prevented from deviating outwards.

92. The SSD doubler of claim 78, wherein the bay body has an opening hole on an arbitrary horizontal surface of a bay configuration area that is in surface contact with the printed circuit board, and the bay body has a series of connection units for remotely controlling operations on an exposed printed circuit board within the opening hole.

93. The SSD doubler of claim 78, wherein the bay body has a fastening hole on a side surface thereof at a position corresponding that of a fastening hole provided at a side surface of a storage medium when the storage medium is maximally inserted.

94. The SSD doubler of claim 78, wherein the bay body has an operation mode setting unit on an arbitrary horizontal surface of a bay configuration area that is in surface contact with the printed circuit board.

95. The SSD doubler of claim 94, further comprising an operation recognition switch disposed at an upper portion of an end surface of the printed circuit board in which a storage medium entrance of the bay body for convenience of operation.

96. The SSD doubler of claim 95, wherein when the first storage medium and the second storage medium are installed, the controller enables the operation mode setting unit to select one of RAID0, RAID1, SPAN, and an operation mode for individual storage media, and when the operation recognition switch is pressed, the controller enables the operation mode setting unit to deliver the setting status to the controller.

97. The SSD doubler of claim 78, wherein the bay body has a “∩”-shaped groove disposed at a bottom surface so that an LED is disposed thereon.

98. The SSD doubler of claim 78, further comprising an LED light guide unit for an upper bay and an LED light guide unit for a lower lay disposed at both corners of the printed circuit board at a side of the storage medium entrance of the bay body.

99. The SSD doubler of claim 96, wherein the LED light guide unit has a “¬”-shaped opening groove on a bottom surface, and an LED is disposed on a printed circuit board below the opening groove to monitor an operation status.

100. The SSD doubler of claim 78, wherein the bay body has a storage medium fastening hole disposed at the storage medium entrance in the form of a “U”-shaped opening hole so that a storage medium is easily removed by mounting a separate storage medium removal unit on fastening holes at both sides of the storage medium through the “U”-shaped opening hole and then pulling the storage medium removal unit.

101. The SSD doubler of claim 78, wherein a plurality of bay bodies are disposed on the printed circuit board in a stacked structure to form multiple stages of bays.

102. The SSD doubler of claim 78, wherein when there are a plurality of bay bodies, the controller is configured to additionally support an operation mode such as RAID3, RAID5, RAID6, RAID10, RAID50, or RAID60 as the number of storage media increases.

103. The SSD doubler of claim 101, wherein the SSD doubler additionally has a fastening bracket including a through hole on an extension line corresponding to a side fastening hole of an adjacent bay body.

104. The SSD doubler of claim 78, further comprising a light emitting unit for optical transmission disposed alongside connectors constituting the second connector portion and configured to output operation monitoring signals output from the storage media.

105. An SSD doubler of a PCI Express card type, the SSD doubler comprising:
a printed circuit board having PCI Express edge fingers;
at least one bay body fastened in surface contact with the printed circuit board and configured to form a plurality of stacked unit bays;
a first connector portion oriented toward an entrance of the bay body, fastened to the printed circuit board, and configured to correspond to a lower bay of the bay body;
a second connector portion disposed alongside the first connector portion in a forward or backward direction and configured to correspond to an upper bay of the bay body;
a first external interface port connected to the first connector portion; and
a second external interface port connected to the second connector portion.

106. The SSD doubler of claim 105, wherein the bay body is formed in one body.

107. The SSD doubler of claim 105, wherein the bay body is divided into a left body and a right body.

108. The SSD doubler of claim 105, wherein the bay body has a plurality of guide bars configured to guide an inserted storage medium and form stacked bays.

109. The SSD doubler of claim 108, wherein an elastic guide bar configured to press the inserted storage medium downward by means of elasticity is provided at an end of an entrance of each of the guide bars, and a storage medium supporting protrusion is provided at an end portion of the elastic guide bar.

110. The SSD doubler of claim 105, wherein the bay body has side holders positioned at both sides of each of the bays and inwardly protruding from the bay body to push a storage medium by means of elasticity thereof so that a storage medium inserted into each of the bays is stably guided and prevented from deviating outwards.

111. The SSD doubler of claim 105, wherein the bay body has an opening hole on an arbitrary horizontal surface of a bay configuration area that is in surface contact with the printed circuit board, and the bay body has a series of connection units for remotely controlling operations on an exposed printed circuit board within the opening hole.

112. The SSD doubler of claim 105, wherein the bay body has a fastening hole on a side surface thereof at a position corresponding that of a fastening hole provided at a side surface of a storage medium when the storage medium is maximally inserted.

113. The SSD doubler of claim 105, wherein the bay body has an operation mode setting unit on an arbitrary horizontal surface of a bay configuration area that is in surface contact with the printed circuit board.

114. The SSD doubler of claim 113, further comprising an operation recognition switch disposed at an upper portion of an end surface of the printed circuit board in which a storage medium entrance of the bay body for convenience of operation.

115. The SSD doubler of claim 114, wherein when the first storage medium and the second storage medium are installed, the controller enables the operation mode setting unit to select one of RAID0, RAID1, SPAN, and an operation mode for individual storage media, and when the operation recognition switch is pressed, the controller enables the operation mode setting unit to deliver the setting status to the controller.

116. The SSD doubler of claim 105, wherein the bay body has a “∩”-shaped groove disposed at a bottom surface so that an LED is disposed thereon.

117. The SSD doubler of claim 105, further comprising an LED light guide unit for an upper bay and an LED light guide unit for a lower lay disposed at both corners of the printed circuit board at a side of the storage medium entrance of the bay body.

118. The SSD doubler of claim 115, wherein the LED light guide unit has a “¬”-shaped opening groove on a bottom surface, and an LED is disposed on a printed circuit board below the opening groove to monitor an operation status.

119. The SSD doubler of claim 105, wherein the bay body has a storage medium fastening hole disposed at the storage medium entrance in the form of a “U”-shaped opening hole so that a storage medium is easily removed by mounting a separate storage medium removal unit on fastening holes at both sides of the storage medium through the “U”-shaped opening hole and then pulling the storage medium removal unit.

120. The SSD doubler of claim 105, wherein a plurality of bay bodies are disposed on the printed circuit board in a stacked structure to form multiple stages of bays.

121. The SSD doubler of claim 105, wherein when there are a plurality of bay bodies, the controller is configured to additionally support an operation mode such as RAID3, RAID5, RAID6, RAID10, RAID50, or RAID60 as the number of storage media increases.

122. The SSD doubler of claim 105, wherein a unit SSD doubler composed of the first connector portion, the second connector portion, and the bay body is disposed in the same direction as that of the PCIe edge fingers so that the storage medium entrance of the bay body is disposed in a direction opposite to that of the PCIe edge fingers.

123. The SSD doubler of claim 122, further comprising such a unit SSD doubler, wherein the unit SSD doublers are disposed alongside each other in a single-layered structure.

124. The SSD doubler of claim 123, further comprising a cross bar having a vertical connection board fastening hole, wherein the SSD doublers are connected to each other by the cross bar by placing the cross bar in surface contact with the end surface of the bay body of each of the SSD doublers and fastening the SSD doublers to the vertical connection board fastening hole included in the cross bar through a fastening hole of a vertical connection board fastening protrusion of the bay body by means of a fastening unit.

125. The SSD doubler of claim 120, wherein the SSD doubler additionally has a fastening bracket including a through hole on an extension line corresponding to a side fastening hole of an adjacent bay body.

126. The SSD doubler of claim 105, wherein the bay body is made of a transparent material and has a concave-convex groove on a bottom surface that is in surface contact with the printed circuit board, and an LED capable of monitoring an operation status of a storage media installed in the bay body is covered with the concave-convex groove to use the entirety of the bay body as an LED light guide plate and a operation monitoring unit.

127. The SSD doubler of claim 105, wherein the PCI Express edge fingers of the printed circuit board are provided as PCI Express ×1 and are capable of being mounted on any kinds of PCI Express slots.

128. The SSD doubler of claim 105, wherein the printed circuit board has a vent hole to facilitate heat dissipation of a storage medium mounted at a lower portion of the SSD doubler.

129. The SSD doubler of claim 105, wherein the bay body has opening holes for placing external interface connector at left and right sides, and the first external interface port and the second external interface port are disposed on the opening holes.

130. The SSD doubler of claim 105, further comprising a separate LED, wherein logical conjunction is performed on operation monitoring signals output from the first connector portion and the second connector portion to obtain a merged operation monitoring signal, and the merged operation monitoring signal is output through the separate LED.

131. The SSD doubler of claim 105, wherein the printed circuit board has a universal signal input/output IC connected to data input/output pins of the PCI Express fingers, and a fault detection LED is operated according to a signal output from the universal signal input/output IC so that a faulty storage medium is intuitively displayed.

132. The SSD doubler of claim 105, wherein the printed circuit board has a universal signal input/output IC connected to data input/output pins of the PCI Express fingers, and all fault detection LEDs are operated according to all fault signals output from the universal signal input/output IC or a logical conjunction of the individual fault signals in order to display that a fault has occurred in any storage medium.

133. A computer system comprising:
a central processing unit configured to process operations;
a system memory configured to store an operating system, register information regarding various kinds of devices, and an operation processing result;
a memory channel hub configured to connect the central processing unit to a main memory unit to process data input or output;
first PCI Express expansion slots connected to the memory channel hub;
an I/O channel hub connected to the memory channel hub and configured to connect various kinds of sub-devices, the I/O channel hub having a RAID function block;
second PCI Express expansion slots connected to the I/O channel hub;
SATA ports;
USB ports;
peripheral devices including a ROM bios;
a non-volatile storage device having an operating system installed therein,
wherein an SSD doubler is inserted into any PCI Express slot of the computer system, and
wherein the SSD doubler comprises:
a printed circuit board having a series of PCI Express edge fingers;
at least one bay body fastened in surface contact with the printed circuit board and configured to form a plurality of stacked unit bays;
a first connector portion configured to correspond to a lower bay of the bay body;
a second connector portion disposed alongside the first connector portion in a forward or backward direction and configured to correspond to an upper bay of the bay body;
storage media accommodated in the bays formed by the bay body and configured to correspond to the first connector portion and the second connector portion;
a first external interface port connected to the first connector portion; and
a second external interface port connected to the second connector portion.

134. The computer system of claim 133, wherein the SSD doubler is inserted into at least one PCI Express slot, and external interface ports of the SSD doubler are correspondingly connected to external interface ports provided on a motherboard.

135. The computer system of claim 133, wherein the SSD doubler is logically recognized as a single storage space or a plurality of storage spaces according to RAID settings of an arbitrary chipset provided on a motherboard.

136. The computer system of claim 133, wherein the central processing unit is configured to display a graphic user interface residing on the main memory unit on a monitor, read a status register of the main memory unit, and display whether a storage medium is present in the installed SSD doubler depending on a value of the status register.

137. The computer system of claim 133, wherein the central processing unit checks statuses of the storage media at predetermined intervals through a program residing on a system memory unit while there is no data access to the storage media, and records fault information in a fault register when it is determined that a fault has occurred in any storage medium.

138. The computer system of claim 133, wherein the central processing unit displays a graphic user interface residing on the main memory unit on a monitor to indicate an SSD doubler marked with a default status, selects one status of an SSD doubler installed in a computer among a vertical status, a horizontal status, an inverse vertical status, and an inverse horizontal status according to a user's manipulation, and displays the status in which the SSD doubler is mounted inside the computer system in order to realistically represent, through a graphic user interface, a fault having occurred in a storage medium installed in an arbitrary position while the SSD doubler having storage media installed therein is used.

139. The computer system of claim 138, wherein the central processing unit stores a mounted status of the SSD doubler finally selected from the graphic user interface in a status information register, stores the status information register in the non-volatile storage device when the computer system ends, reads a fault detection register of the main memory unit while the computer system is used, and displays a position of a faulty storage medium on an image of the SSD doubler indicating a current placement status on the graphic user interface according to the status information register when a default bit is detected.

140. The computer system of claim 133, wherein the central processing unit displays a graphic user interface residing on the main memory unit on a monitor, places, on the graphic user interface, an SSD doubler and/or an individual storage medium to which the graphic user interface is intended to be applied, and displays whether the storage medium is present and whether a fault has occurred in the storage medium in association with a status information register.

141. The computer system of claim 133, wherein the printed circuit board has a universal signal input/output IC connected to data input/output pins of the PCI Express fingers, and the central processing unit reads a fault detection register of the main memory unit and transfers a value of the read fault detection register to an SSD doubler having the universal signal input/output IC built therein when a fault has occurred.

142. The computer system of claim 141, wherein the SSD doubler has fault indication LEDs and operates a fault indication LED for a storage medium disposed at a corresponding position according to a fault detection signal output by the universal signal input/output IC.

143. A multi-device bay system comprising:
an SSD doubler having a multi-interface port;
a backplane board having a first connection unit correspondingly connected to the multi-interface port of the SSD doubler at a front surface;
at least one PCI Express slot provided at a rear surface of the backplane board;
an external interface card installed at one side of the PCI Express slot; and
a RAID card installed at the other side of the PCI Express slot.

144. The multi-device bay system of claim 143, wherein the backplane board has a second connection unit composed of a plurality of connectors and correspondingly connected to the first connection unit.

145. The multi-device bay system of claim 143, wherein in the PCI Express slot, pins of a PCI Express slot connector having the external interface card are correspondingly connected to pins of a PCI Express slot connector having the RAID card.

146. The multi-device bay system of claim 144, wherein a SATA (or SATA Express or SAS) or PCI Express connection port of the RAID card provided on the PCI Express slot connector is connected to the second connection unit provided on the rear surface of the backplane board.
